(19) United States
(12) Patent Application Publication
(10) Pub. No.: US 2015/0371763 A1
(43) Pub. Date: Dec. 24, 2015

(54) NESTED-HELICAL TRANSFORMER

(71) Applicant: International Business Machines Corporation, Armonk, NY (US)

(72) Inventors: Rachel Gordin, Hadera (IL); WAN NI, San Jose, CA (US); Michael J. Shapiro, AUSTIN, TX (US); William F. Van Duyne, San Diego, CA (US)

(21) Appl. No.: 14/310,054

(22) Filed: Jun. 20, 2014

(51) Int. Cl. H01F 27/28; H01F 41/04

(52) U.S. Cl. CPC H01F 27/2823; H01F 41/041

(57) ABSTRACT

Some examples describe a first helical electromagnetic coil of a transformer. In some instances, at least a portion of the first helical electromagnetic coil is inside a first semi-conductive substrate. Further, in some examples, the first helical electromagnetic coil has a shape with an internal space. Further, some examples describe a second helical electromagnetic coil of the transformer. In some instances, at least a portion of the second helical electromagnetic coil is nested within the internal space of the first helical electromagnetic coil. Further, in some examples, the at least the portion of the second electromagnetic coil is inside the first semi-conductive substrate.

### BACKGROUND

The description herein generally relates to the field of semi-conductors and, more particularly, to electromagnetic coils associated with integrated circuits.

An electromagnetic coil is an electrical conductor such as a wire in the shape of a coil or spiral. Electromagnetic coils are in electronic elements where electric currents interact with magnetic fields. Some devices that utilize electromagnetic coils include inductors, electromagnets, transformers, and sensor coils. An electric current that is passed through the wire of the electromagnetic coil generates a magnetic field. Conversely an external time-varying magnetic field through the interior of the electromagnetic coil generates an electromotive force (e.g., a voltage) in the conductor.

### SUMMARY

Some embodiments of the inventive subject matter include an electronic device having a first helical, electromagnetic coil structure (outer helical-coil structure) and a second helical electromagnetic coil structure (inner helical-coil structure) nested within the outer helical-coil structure.

In some embodiments, the outer helical-coil structure is a first portion of a single inductor coil. The inner helical-coil structure is a second portion of the inductor coil. The second portion of the indictor coil is contained within a helically shaped frame of the outer helical-coil structure. The first portion is connected to the second portion via a transitional structure that allows the first portion of the inductor coil to bend, or turn, within itself, and transition into the second, nested portion. In some examples, sides of the outer helical-coil structure are formed through at least a portion of a substrate, such as by using first vias (e.g., through-silicon vias or TSVs). Further, sides of the inner helical-coil structure can be formed through at least a portion of the substrate, such as by using second vias.

In some embodiments, the outer helical-coil structure is a first (e.g., primary) coil of a transformer. The inner helical-coil structure is a second (e.g., secondary) coil of the transformer. The second coil (“inner coil”) is nested within the first coil (“outer coil”). In some embodiments, sides of the outer coil are formed through at least a portion of a substrate, such as by using first vias (e.g., TSVs). In some embodiments, sides of the inner helical-coil structure are also formed through at least a portion of the substrate, such as by using second vias.

### BRIEF DESCRIPTION OF THE DRAWINGS

The present embodiments may be better understood, and numerous objects, features, and advantages made apparent to those skilled in the art by referencing the accompanying drawings.

FIGS. 1, 2, 3A, 3B, 4, 5 and 6 illustrate an example nested helical inductor 100.

FIGS. 7-11 illustrate an example nested helical inductor formed in multiple strata of a semi-conductive device.

FIGS. 12-14 illustrate an example nested helical transformer 1200.

FIG. 15 illustrates an example nested helical transformer 1500 formed in multiple strata of a semi-conductive device.

FIGS. 16-17 illustrate an example nested helical transformer 1600 formed in multiple strata of a semi-conductive device.

FIG. 18 illustrates an example of two nested helical transformers 1820 and 1830 with symmetrical windings.

FIG. 19 is a flowchart depicting example operations for forming a nested helical inductor according to some embodiments.

FIG. 20 is a flowchart depicting example operations for forming a nested helical transformer according to some embodiments.

FIG. 21 illustrates an example computer system 2100.

### DESCRIPTION OF EMBODIMENT(S)

The description that follows includes example systems, methods, techniques, instruction sequences and computer program products that embody techniques of the present inventive subject matter. However, it is understood that the described embodiments may be practiced without these specific details. For instance, although examples refer to inductors and transformers, other examples can include any type of electromagnetic coil used in a semi-conductive device. In other instances, well-known instruction instances, protocols, structures and techniques have not been shown in detail in order not to obfuscate the description.

In the semi-conductor industry, there is an ever increasing need to place more electronic components on a chip (e.g., an integrated circuit). Furthermore, there is an ever increasing need to make chips function better than before. One way to do this is to reduce power consumption of a chip. One way to reduce power consumption on a chip is to use a regulator, such as a switching voltage regulator or a buck converter. Some regulators can utilize inductors and/or transformers. In some cases, such as for a buck converter, a larger inductor and/or transformer can improve voltage regulation. To increase a size of an inductor and/or transformer, more space is required on a chip. However, space on a chip is limited.

Described herein are examples of inductors and transformers with nested electromagnetic coil elements formed into one or more strata of chips and chip packages. For example, the inductor and/or transformer can be formed in three-dimensions of a semi-conductive substrate. The inductor and/or transformer can have a specific nested helical configuration with windings that wind through the three dimensions of the substrate and/or through multiple layers of substrates, packages, etc. In some embodiments, vias and/or micro-bumps are used to form the inductor and/or transformer through a thickness (e.g., a vertical dimension) of the substrate and/or through the multiple layers of substrates, packages, etc.

A substrate, is a solid (usually planar) layer of substance onto which a layer of another substance is applied, and to which that second substance adheres. In some instances, a substrate can be a semi-conductive material, an electrical insulator, some combination, etc. Different types of substrates can be used for different types of fabrication process. Many integrated circuits (ICs) are fabricated onto substrates that include at least a layer of semi-conductive material. Semi-conductive materials include elements and compounds that have semiconducting properties. Some substrate materials can include one or more of electronic grade (i.e., pure) silicon, silicon dioxide, aluminum oxide, sapphire, germanium, gallium arsenide (GaAs), an alloy of silicon and germanium, or indium phosphide (InP). In some instances, the substrate is formed into thin disks called wafers. For example, a semi-conductive material is formed into, or cut out as, thin-disc wafers. Individual electronic devices can be fabricated (e.g., etched, deposited, or otherwise formed) onto the wafers (e.g., via a photolithography process). The wafer can then be cut (“diced”) into many pieces. Each of these pieces is called a die. Each die may include a copy of an integrated circuit.

Inductors, or reactors, are coils which generate a magnetic field which interacts with the coil itself, to induce a back electro-magnetic field (EMF) which opposes changes in current through the coil. Inductors are used as circuit elements in electrical circuits, to temporarily store energy or resist changes in current. An inductor is characterized by its inductance (L), the ratio of the voltage to the rate of change of current, which has units of henries (H). Inductance (L) results from the magnetic field around a current-carrying conductor: the electric current through the conductor creates a magnetic flux. Inductance is determined by how much magnetic flux through the circuit is created by a given current.

A transformer is an electrical component with two or more magnetically coupled windings (or sections of a single winding). A time varying current in one coil (typically called the primary winding) generates a magnetic field which induces a voltage in the other coil (typically called the secondary winding).

A via (vertical interconnect access) is a vertical electrical connection between layers in a physical electronic circuit that goes through the plane of one or more adjacent layers. A via can pass through only a portion of the adjacent layers, such as blind vias and buried vias. A via can also pass through all the adjacent layers of the physical electronic circuit. Vias that pass through all adjacent layers of the physical electronic circuit may be referred to as through vias. A through-silicon via (TSV) is a type of through via that can pass completely through a silicon wafer or die. TSVs can be used to create 3D packages and 3D integrated circuits.

A micro-bump, or micro-pillar, is a microscopic sized, raised bump or pillar of conductive material used for connections between electrical components. In some examples, the micro-bump is a highly-conductive, low-resistance metal, such as copper, gold, silver, or aluminum. Micro-bumps may be formed by thermoelectric cooling techniques, thin-film thermoelectric techniques, controlled collapse chip connection (C3 or C4) techniques, copper pillar solder bump (CPB) techniques, etc. A micro-bump can be used for 3D stacking.

Nested Helical Inductor

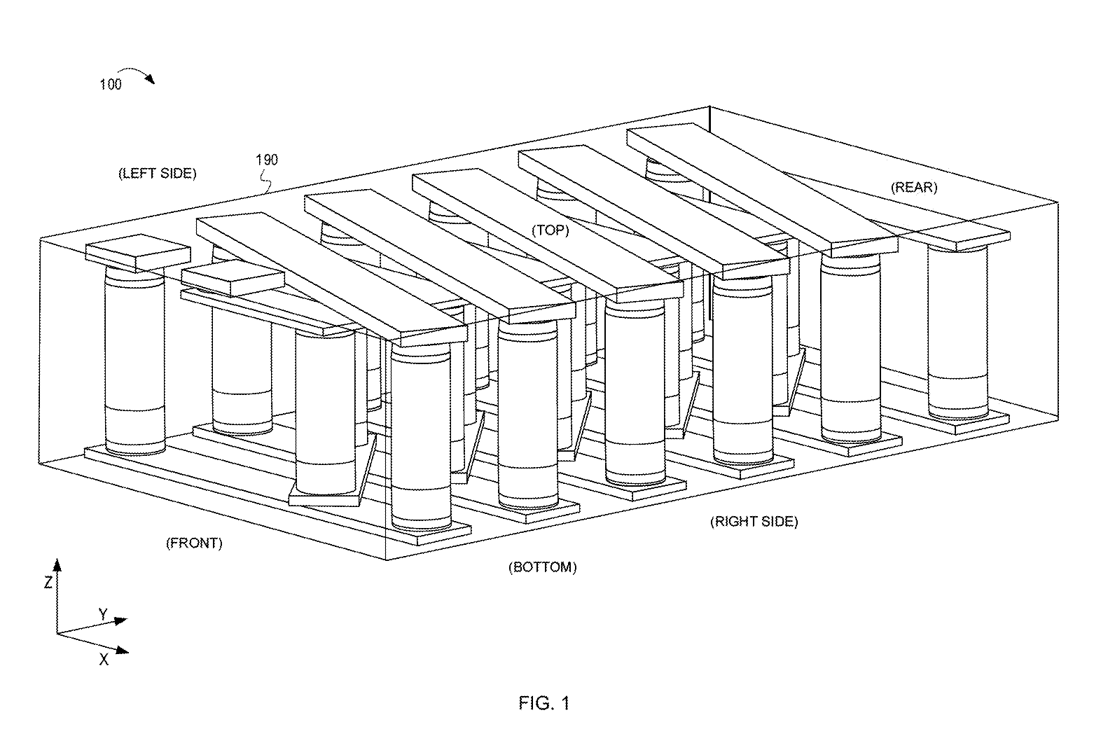

FIG. 1 illustrates a nested, helical electromagnetic inductor coil (“inductor 100”) that is formed into a semiconductor substrate 190. Dimensional indicators show an “X” value which indicates a “horizontal” dimension from left to right, or vice versa. A “Y” value which indicates a horizontal dimension from front to back, or vice versa. A “Z” value indicates a vertical dimension from top to bottom, or vice versa. A portion of the inductor 100 (an “inner” portion) is nested, or contained, within another portion (an “outer” portion) of the inductor 100.

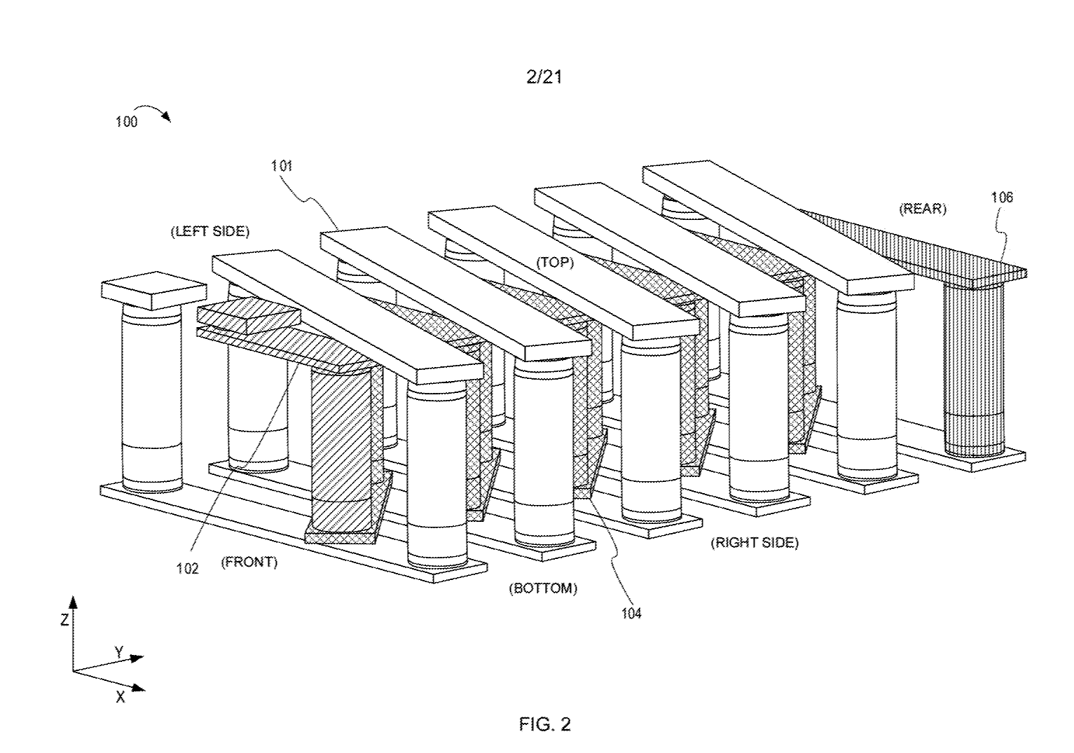

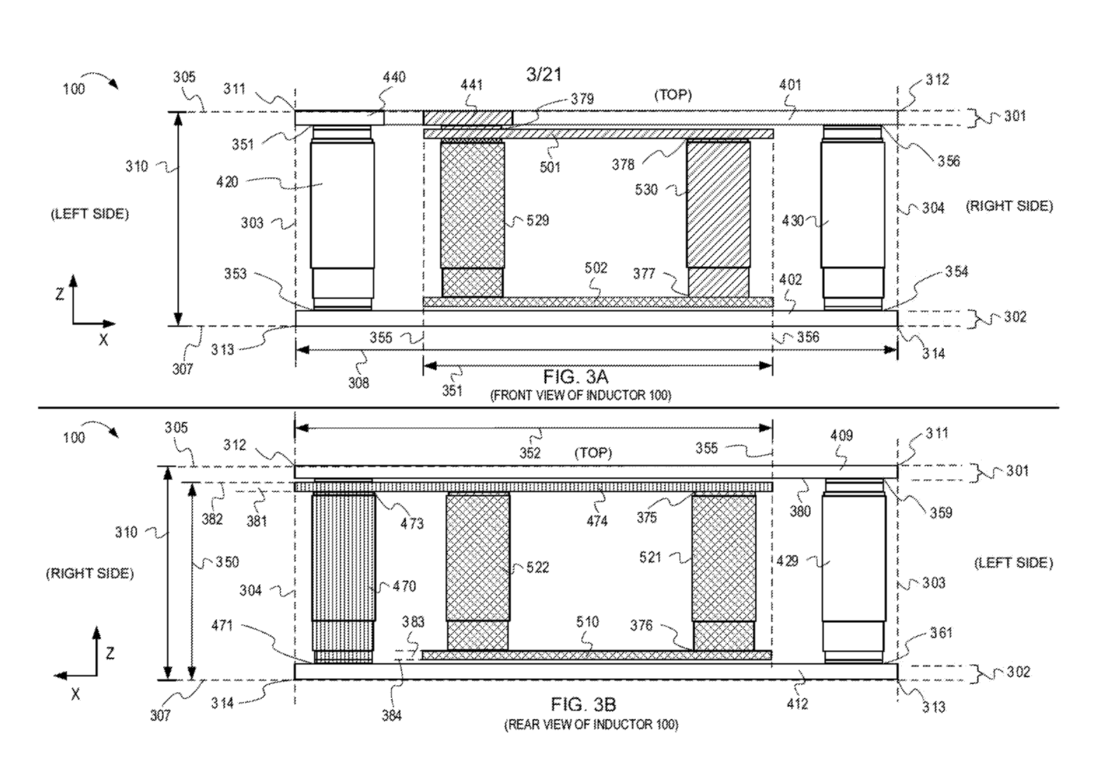

FIG. 2 illustrates the inductor 100 with a non-shaded part (section 101) that represents the “outer” portion of the inductor 100 and shaded parts (sections 102 and 104) that represent the “inner” or “nested” portion of the inductor 100. A transitional section 106 transitions the outer portion to the inner portion. In FIG. 2 (and in other Figures herein), the semiconductor substrate 190 (shown in FIG. 1) is removed from view so as not to obscure some of the details of the inductor 100. However, although the semiconductor substrate 190 may not be illustrated, it should still be assumed as present. In FIG. 2, section 101 of the inductor 100 comprises a first structure (i.e., an outer helical structure), with a spatial form or structural frame that is shaped generally like a specific type of double-helix. The spatial form or structural frame of the first structure will be referred to herein as a “helically-shaped frame” or “frame.” Windings of the outer helical structure are shaped as if wound around an orthogonal polyhedron (e.g., a block or box). In other words, the spiral pattern of the windings in the outer helical structure have angular transitions (e.g., square angle transitions) as the windings move from a metal wire to a via, and so forth. The result is that a cross-sectional shape of the frame is an box shape (e.g., a cuboid). Therefore, the frame may also be referred to herein as a “cuboid, double-helix” frame or a “box-helix” frame. In some embodiments, the box shape is a result of some semi-conductor fabrication processes that form and etch layers of substrates and materials in substantially planar layers and according to angular dimensions. The sections 102 and 104 of the inductor 100 comprise a second structure (i.e., an inner helical structure) also with a helically-shaped frame. The inner helical structure is nested, or contained, within the helically-shaped frame of the outer helical structure. Similar views of the same inductor 100 are illustrated in FIGS. 3A-3B, and 4-6, which, among other details, describe in further detail a frame 586 for the inner helical structure that is nested within a frame 485 of the outer helical structure.

Referring still to FIG. 2, the transitional section 106 is configured to bend, or turn, the electromagnetic coil of the inductor 100 approximately 180 degrees within itself and transition to smaller coil dimensions so that the inner helical structure can fit within the frame of the outer helical structure.

Furthermore, FIGS. 1 and 2 illustrate orientation indicators (e.g., a front, a back, a left side, a right side, a top, and a bottom) of the inductor 100. Equivalent orientation indicators are used in FIGS. 3A-3B, and 4-6 for reference.

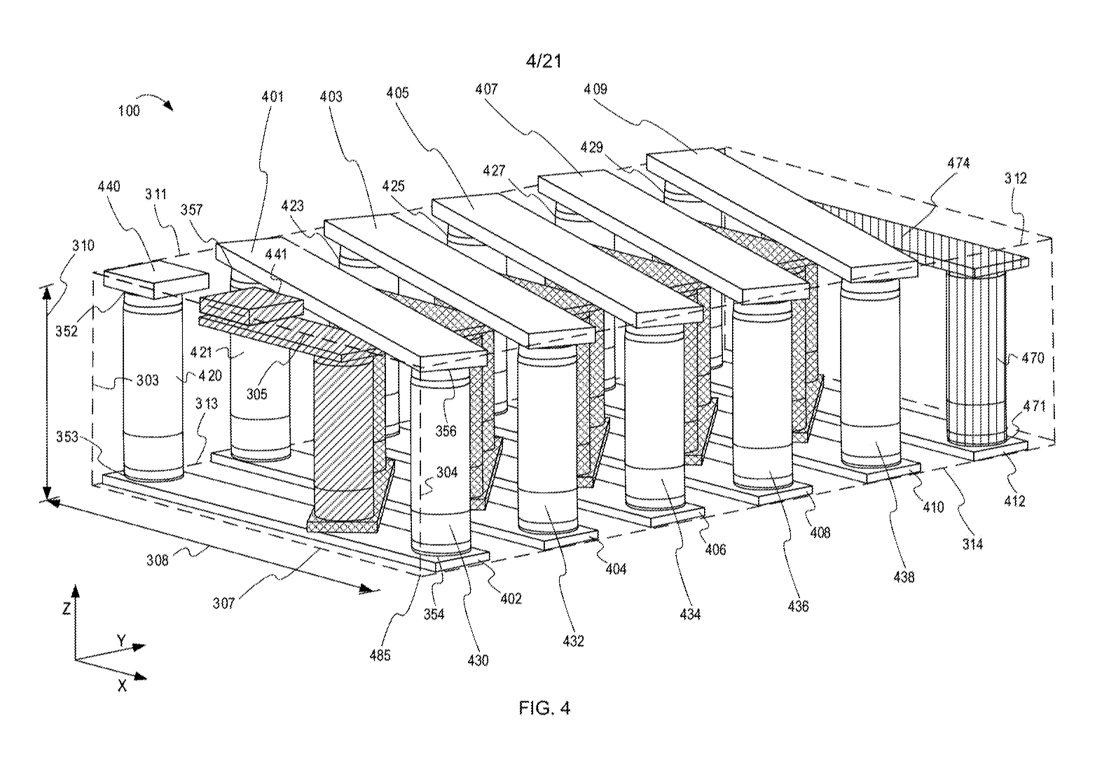

FIG. 3A illustrates a front view of inductor 100 illustrated in FIG. 2. FIG. 3B illustrates a rear view of the inductor 100 illustrated in FIG. 2. FIG. 4 illustrates the inductor 100 with additional details. In the following paragraphs, FIGS. 3A, 3B and 4 will be referred to repeatedly.

Referring first to FIG. 3A, to form the outer helical structure, an upper metal layer 301 is formed into an upper portion of a semi-conductive substrate. A top of the upper metal layer 301 aligns with an upper horizontal plane 305 A lower metal layer 302 is formed into a lower portion of the semi-conductive substrate. The lower metal layer 301 may be a thick metal layer, such as a redistribution layer (RDL). A bottom of the lower metal layer 302 aligns with a lower horizontal plane 307. The upper metal layer 301 is above, and parallel to, the lower metal layer 302. Referring momentarily to FIG. 4, first metal wires 401, 403, 405, 407, and 409 are formed from the upper metal layer 301. The upper metal layer 301 may be a thick metal layer. The first metal wires 401, 403, 405, 407, and 409 are part of an upper portion of the outer helical structure. The first metal wires 401, 403, 405, 407, and 409 wind, or coil across the width 308 of the outer helical structure in a direction from front-to-back of the inductor 100. The upper horizontal plane 305 is at the top of the outer helical structure and a top surface of each of the first metal wires 401, 403, 405, 407, and 409 is coplanar with the upper horizontal plane 305. The second metal wires 402, 404, 406, 408, 410, and 412 are formed from the lower metal layer 302. The second metal wires 402, 404, 406, 408, and 410, and 412 are part of a lower portion of the outer helical structure. The second metal wires 402, 404, 406, 408, and 410, and 412 wind, or coil across the width 308 of the outer helical structure. The lower horizontal plane 307 is at the bottom of the outer helical structure and a bottom surface of each of the second metal wires 402, 404, 406, 408, and 410, and 412 are coplanar with the lower horizontal plane 307.

The upper portion of the outer helical structure and the lower portion of the outer helical structure have the same width 308, such that a first edge of the upper portion of the outer helical structure (edge 311) lines up vertically (along a vertical plane 303) with a first edge of the lower portion of the outer helical structure (edge 313). The vertical plane 303 is at a left side of the outer helical structure. Likewise, a second edge of the upper portion of the outer helical structure (edge 312) lines up vertically (along a vertical plane 304) with a second edge of the lower portion of the outer helical structure (edge 314). The vertical plane 304 is at a right side of the outer helical structure. The right side of the outer helical structure and the left side of the outer helical structure have the same vertical height 310.

Vias 420, 421, 423, 425 and 427 and 429 connect the first metal wires 401, 403, 405, 407, and 409 to the second metal wires 402, 404, 406, 408, 410, and 412 on the left side of the outer helical structure. Vias 430, 432, 434, 436, and 438 connect the metal wires 401, 403, 405, 407, and 409 to the metal wires 402, 404, 406, 408, and 410 on the right side of the outer helical structure.

Referring to both FIG. 3A and FIG. 4, the outer helical structure begins at a metal connector 440 situated at a front of the inductor 100. The metal connector 440 connects to a first end (i.e., a top) of the via 420 at a first connection 352. The via 420 extends vertically downward through the substrate to a second connection 353. A second end (i.e., a bottom) of the via 420 connects with the metal wire 402 at a second connection 353. The metal wire 402 winds, or coils, across the width 308 from the second connection 353 to a third connection 354. As the metal wire 402 coils across the width 308, a bottom surface of the metal wire 402 remains coplanar with the lower horizontal plane 307. The third connection 354 connects the metal wire 402 to the bottom of the via 430. The via 430 extends vertically upward through the substrate to a fourth connection 356. The fourth connection 356 connects the top of the via 430 to the metal wire 401. The metal wire 401 winds, or coils, across the width 308 in a front-to-back direction (i.e., in the “Y” direction), from the fourth connection 356 to a fifth connection 357 (shown in FIG. 4). The fifth connection 357 connects a top of the via 421 to the metal wire 401. As the metal wire 401 coils across the width 308, a top surface of the metal wire 401 remains coplanar with the upper horizontal plane 305. The first connection 352 and the fifth connection 357 are adjacent to each other and are separated by a specific separation distance sufficient to insolate the first connection 352 from the fifth connection 357 and/or prevent the first connection 352 from causing a significant electrical interference on the fifth connection 357. The portion of the outer helical structure from the first connection 352, down through the via 420 to the second connection 353, across the metal wire 402 to the third connection 354, up the via 430 to the fourth connection 356, and across the metal wire 401 to the fifth connection 357 may constitute one winding, or spiral, of the outer helical structure. The pattern repeats for a second winding, and so forth, until reaching a back of the inductor 100.

Referring now to FIGS. 3B and 4, at the back of the inductor 100, the metal wire 409 connects to a top of via 429 at connection 359. The via 429 extends from the connection 359 downward through the substrate to a connection 361 for the outer helical structure. Metal wire 412 is connected to a bottom of the via 429 at the connection 361. Metal wire 412 extends from the connection 361, left-to-right (according to the orientation markers shown in FIG. 3B) across the width 308 of the outer helical structure and connects to a bottom part of a transitional via (via 470) at a lower transitional connection 471. The outer helical structure terminates at the lower transitional connection 471.

The upper horizontal plane 305, the lower horizontal plane 307, the vertical plane 303, and the vertical plane 304 intersect at the edges 311, 312, 313, and 314. The overall shape defines a frame 485 for the outer helical structure. A space exists within the frame 485 of the outer helical structure. The transitional via 470 connects the outer helical structure to portions of the inner helical structure configured to fit within the space inside the frame 485 of the outer helical structure. As illustrated in FIG. 4, windings of the outer helical structure are not shaped as if wound around a cylinder. Rather, the windings of the outer helical structure are shaped as if wound around an orthogonal polyhedron (e.g, a block, box, cuboid, etc.). In other words, the spiral pattern of the windings in the outer helical structure have angular transitions (e.g., square angle transitions) as the windings move from a metal wire to a via, and so forth. The result is that a cross-sectional shape of the frame 485 is a rectangular (including a square) or box shape. Therefore, the frame 485 may also be referred to as a “cuboid, double-helix” frame or a “box-helix” frame. In some embodiments, the box shape is a result of some semi-conductor fabrication processes that form and etch layers of substrates and materials in substantially planar layers and according to angular dimensions. Furthermore, because the frame 586 is contained within the frame 485, the inductor 100 has two helixes, with one embedded in the other. Thus, herein the inductor 100 may be referred to herein as a “nested, multi-helical” structure, or more succinctly as a “nested helical” structure.

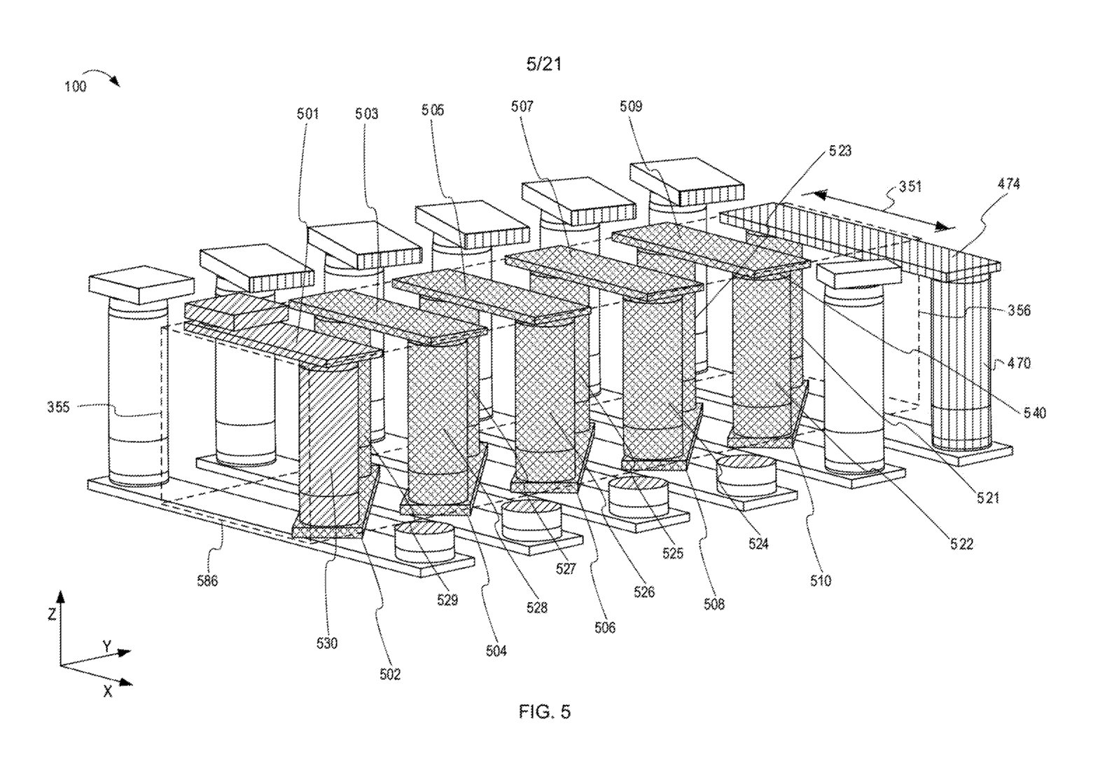

As mentioned, the outer helical structure terminates at the lower transitional connection 471. The transitional via 470 extends upward through the substrate and connects to a transitional metal wire 474 at connection 473. The transitional metal wire 474 is formed from a third metal layer 381 that is below the upper metal layer 301. The third metal layer 381 may be a thick metal layer. The transitional metal wire 474 has a horizontal width 390. A horizontal plane 382 aligns with a top surface of the transitional metal wire 474. The horizontal plane 382 is below the upper horizontal plane 305, such that a height 350 from the lower horizontal plane 307 to the horizontal plane 382 is shorter than the height 310 from the lower horizontal plane 307 to the upper horizontal plane 305. Thus, the transitional via 470 is shorter than via 429, or any of the other vias 420, 421, 423, 425, 427, 429, 430, 432, 434, 436 or 438, which belong to the outer helical structure. The transitional via 470 is shorter in vertical height than any of the vias of the outer helical structure because the transitional via 470 transitions the outer helical structure to the inner helical structure. In other words, the height of the transitional via 470 is short enough so that a top of the transitional via 470 (i.e., the top surface of the transitional metal wire 474) is lower than a bottom surface 380 of the metal wire 409 from the outer helical structure, without touching each other. Additional metal wires for the inner helical structure (i.e., third metal wires 501, 503, 505, 507, and 509 shown in FIG. 5) are also formed from the third metal layer 381. Thus the top surfaces of the additional metal wires are also coplanar with the horizontal plane 382 and do not touch bottom surfaces of the first metal wires 401, 403, 405, 407, and 409. Thus, an upper boundary of the inner helical structure, is underneath the upper metal layer 301. Therefore, the inner helical structure fits within (i.e., is nested within) the space inside the frame 485 of the outer helical structure. In other words, the inner helical structure and the outer helical structure are concentric.

The following paragraphs will refer now to FIGS. 3A, 3B, and 5. Referring first to FIG. 5, the inner helical structure is formed similar to that of the outer helical structure. Portions of the outer helical structure have been removed from view so that the inner helical structure can be more fully described. The inner helical structure includes the third metal wires 501, 503, 505, 507, and 509 formed in the third metal layer 381 (shown in FIG. 3B). The third metal wires 501, 503, 505, 507, and 509 wind, or coil horizontally right-to-left across a width 351 of the inner helical structure. A top surface of each of the third metal wires 501, 503, 505, 507, and 509 is coplanar with the horizontal plane 382. As the third metal wires 501, 503, 505, 507, and 509 coil across the width 351, the top surfaces of the third metal wires 501, 503, 505, 507, and 509 remain coplanar with the horizontal plane 382.

The inner helical structure also includes fourth metal wires 502, 504, 506, 508, and 510 formed in a fourth metal layer 383. The fourth metal layer 383 may be a thick metal layer, such as another RDL layer in additional to the lower metal layer 302. The fourth metal wires 502, 504, 506, 508, and 510 wind, or coil across the width 351 of the inner helical structure in a direction from back-to-front of the inductor 100. A bottom surface of each of the fourth metal wires 502, 504, 506, 508, and 510 is coplanar with a horizontal plane 384. As the metal wires 502, 504, 506, 508, and 510 coil across the width 351, the fourth metal wires 502, 504, 506, 508, and 510 remain coplanar with the horizontal plane 384. Furthermore, the bottom surfaces of the fourth metal wires 502, 504, 506, 508, and 510 do not touch a top surface of the second metal wires 402, 404, 406, 408, 410, and 412.

One edge of the third metal wires 501, 503, 505, 507, and 509 (on a left side of the inner helical structure), aligns with a vertical plane 355. One edge of the fourth metal wires 502, 504, 506, 508, and 510 also aligns with the vertical plane 355. Another edge of the third metal wires 501, 503, 505, 507, and 509 (on a right side of the inner helical structure), aligns with a vertical plane 356. Another edge of the fourth metal wires 502, 504, 506, 508, and 510 also aligns with the vertical plane 356. The vertical plane 355 and the vertical plane 356 are substantially parallel.

As shown in FIG. 3B, the transitional wire 474 coils (from right to left) within the metal layer 381 across the width 390 to a connection 375 at a top of via 521. The via 521 is one of a set of vias (i.e., vias 521, 523, 525, 527, and 529) on the left side of the inner helical structure. The vias 521, 523, 525, 527, and 529 connect the third metal wires 501, 503, 505, 507 and 509, at the left side of the inner helical structure, to the fourth metal wires 502, 504, 506, 508, and 510. Another set of vias (i.e., vias 522, 524, 526, 528, and 530) connect the third metal wires 501, 503, 505, 507 and 509, at the right side of the inner helical structure, to the fourth metal wires 502, 504, 506, 508, and 510. The vias of the inner helical structure (i.e., vias 521, 522, 523, 524, 525, 526, 527, 528, 529, and 530) are shorter in height than the vias of the outer helical structure (i.e., vias 420, 421, 423, 425, 427, 429, 430, 432, 434, 436, and 438). Furthermore, vias of the inner helical structure are also shorter in height than the transitional via 470.

Referring back to FIG. 3B, the via 521 extends from the connection 375 vertically downward through the substrate to a connection 376. Metal wire 510 is connected to the bottom of via 521 at the connection 376. The metal wire 510 winds, or coils, left to right (according to the orientation indicators of FIG. 3B) across the width 351 (i.e., the width of the inner helical structure) in the direction toward the front of the inductor 100. Referring now to FIG. 5, the metal wire 510 connects to a bottom of via 522. The via 522 extends, from the metal wire 510, vertically upward through the substrate, and connects (at connection 540) to the metal wire 509. The metal wire 509 winds, or coils, right to left across the width 351, until it connects with a top of via 523. The portion of the inner helical structure from the connection 375, down through the via 521, across the metal wire 510, up through via 522, and across the metal wire 509 may constitute one winding, or spiral, of the inner helical structure. The pattern repeats for a second inner winding, and so forth, until reaching the front of the inductor 100. Thus, a frame 586 of the inner helical structure is formed. The frame 586 may also be referred to as a “rectangular, double-helix” frame or a “box-helix” frame because the windings of the inner helical structure have a shape as if being wound around a rectangular (including square and/or oblong) box form.

Referring back to FIG. 3A, at the front of the inductor 100, the metal wire 502 connects to a bottom of the via 530 at a connection 377. The via 530 extends upward through the substrate until connecting to metal wire 501 at connection 378. The metal wire 501 then coils (right to left) across the width 351 and connects to metal connector 441 at connection 379. In some embodiments, the connector 441 is formed from the upper metal layer 301. A conductive layer (a thickness equivalent to the space between the third metal layer 381 and the upper metal layer 301) can be formed between the connector 441 and the metal wire 501 to provide electrical connection between the metal wire 501 and the connector 441.

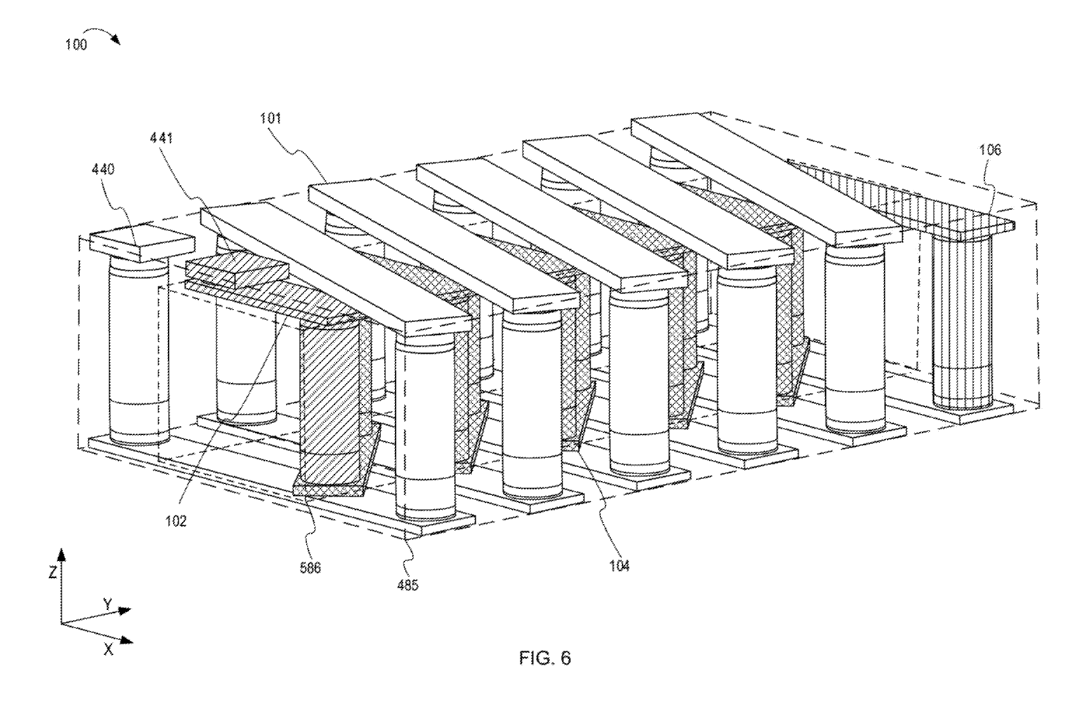

Referring now to FIG. 6, the frame 586 is contained within the frame 485. Further, in some embodiments, the metal connector 440 is an electrical input for the inductor 100 and the metal connector 441 is an electrical output for the inductor 100. An electrical current can flow between the metal connector 440 and the metal connector 441, for instance, from the metal connector 440, through the outer helical structure (i.e., through section 101), through the transitional portion 106, into and through the inner helical structure (i.e., through section 104 and through section 102), to the metal connector 441. In other words, the outer helical structure is configured to carry the electrical current from the input (at metal connector 440) in a first direction to the transitional portion (section 106) at the back of the inductor 100. The inner helical structure is configured to receive the current from the outer helical structure via the transitional portion (section 106) at the back of the inductor 100 and carry the current in a second direction, opposite to that of the first direction, until reaching the output at the metal connector 441, or vice versa. As such, the outer helical structure and the inner helical structure enclose the same magnetic flux. Consequently, the inductor 100 has a greater inductance density than an inductor without nested helical structures. Further, because the inner helical structure is contained in the space within the outer helical structure, then inductor 100 has a better Q-factor per area than an inductor without nested helical structures. The Q-factor (quality factor) of an inductor is the ratio of its inductive reactance to its resistance at a given frequency, and is a measure of its efficiency. The higher the Q factor of the inductor, the closer it approaches the behavior of an ideal, lossless, inductor.

It should be noted that the outer helical structure does not have to be constructed before the inner helical structure, or vice versa. Portions of the outer helical structure may be formed before, in parallel with, or after portions of the inner helical structure are formed. For example, referring to FIGS. 3A, 3B, 4 and 5, the metal layer 302 may be formed first, which is then shaped into the metal wires 402, 404, 406, 408, 410 and 412. Then the metal layer 383 may be formed, which is then shaped into the metal wires 502, 504, 506, 508, and 510. Next, the vias may be formed for both the inner and outer helical structures and for the transitional portion. Next, the metal layer 381 may be formed, which is then shaped into the metal wires 501, 503, 505, 507, 509 and 474. Next, the metal layer 301 may be formed, which is then shaped into metal wires 401, 403, 405, 407, and 409. In some examples, the formation process may be reversed depending on specific fabrication tools, protocols, etc., Further, some vias may be formed before other vias. Further, vias may be formed before, after, or contemporaneously with the formation of metal layers, and so forth.

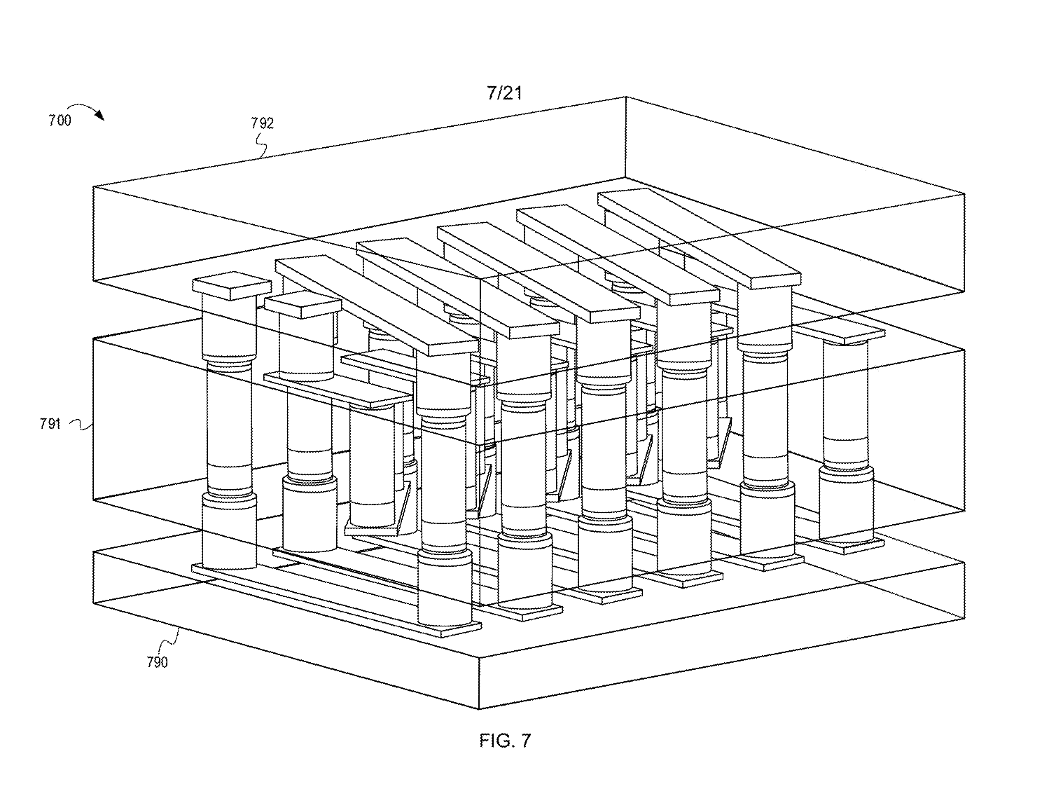

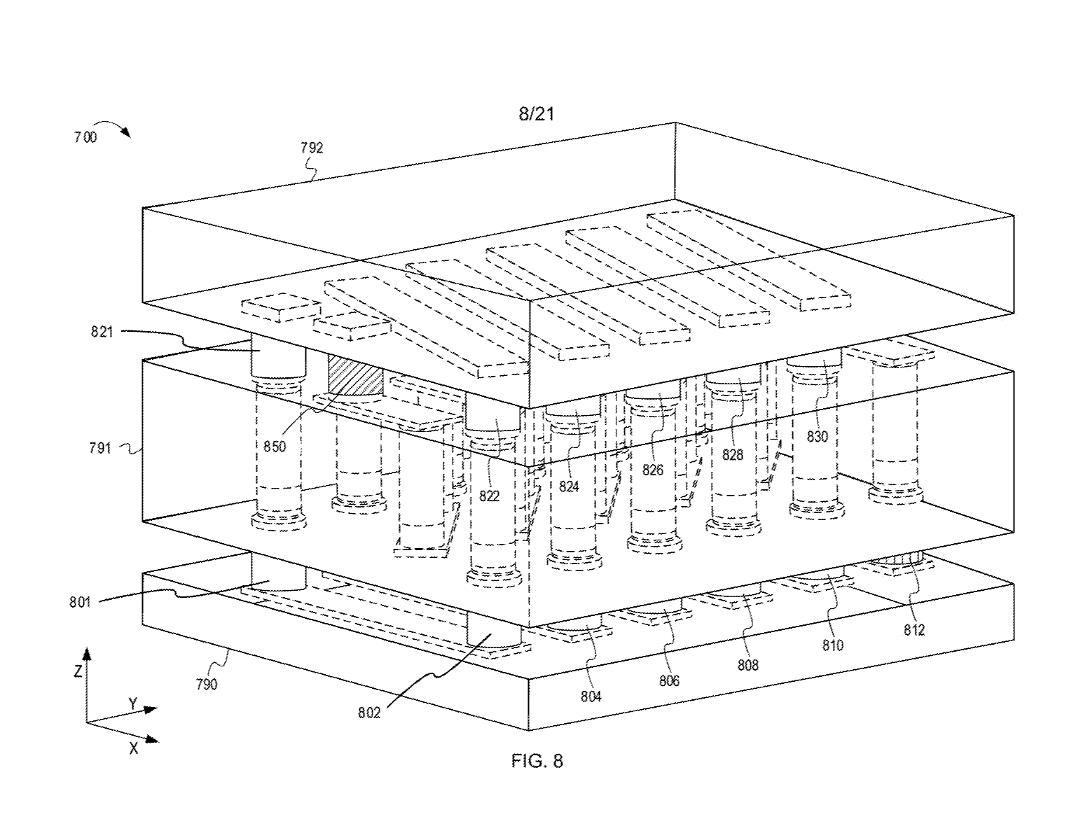

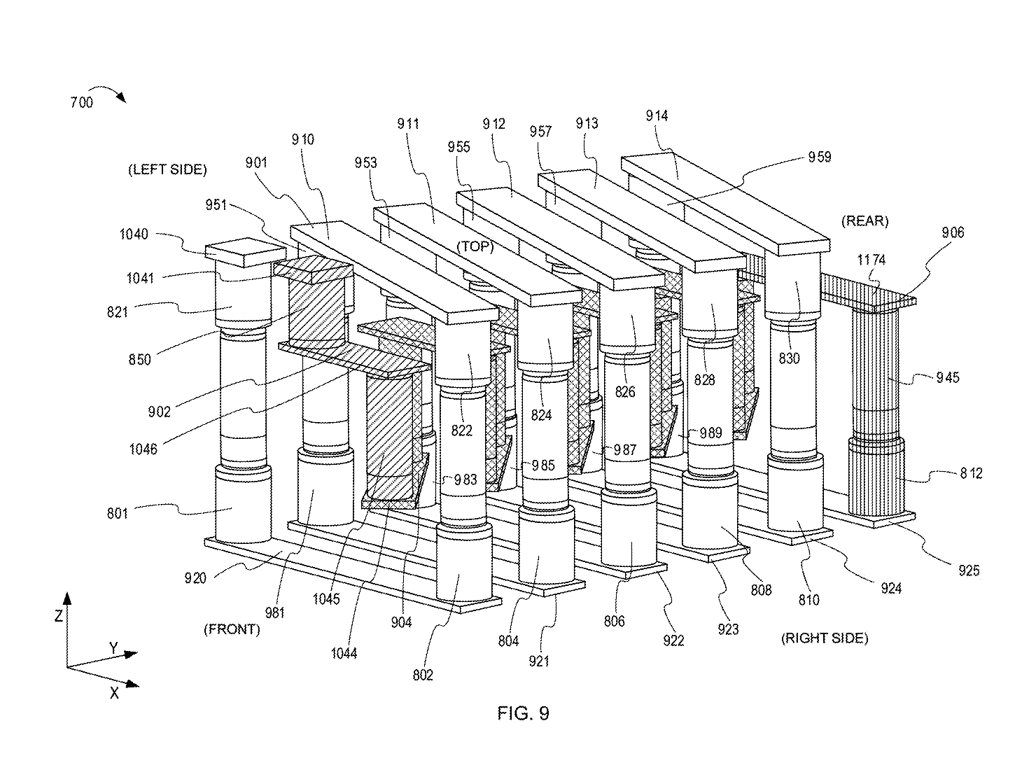

In some embodiments, the nested helical inductor can be formed across multiple strata of a semiconductor structure. For example, portions of the outer helical structure can extend through multiple layers of semiconductor dies and/or packages of electronic devices that have been stacked. FIG. 7 illustrates an example of a nested helical inductor (“inductor 700”) that is formed across multiple strata of a semiconductor structure. In FIG. 7, the inductor 700 is formed into a first stratum 790, a second stratum 791, and a third stratum 792. The first stratum 790, second stratum 791, and third stratum 793 are separate semiconductor substrates for different dies. FIG. 8 shows another illustration of the inductor 700. In FIG. 8 portions of the inductor 700 that are inside the first stratum 790, second stratum 791, and third stratum 793 are illustrated with dashed lines. In between the first stratum 790 and the second stratum 791, as well as in between the second stratum 791 and the third stratum 792, are micro-bumps (also known as micro-pillars). Examples of the micro-bumps include the micro-bumps 801, 802, 804, 806, 808, 810, 812, 821, 822, 824, 826, 828, 830, and 850 shown in FIG. 8. Micro-bumps 801, 802, 804, 806, 808, 810, 821, 822, 824, 826, 828, and 830 constitute a part of the outer helical structure that is not contained within a substrate of a particular die. Micro-bump 812 is part of a transitional section. Micro-bump 812 is not contained within a substrate of a particular die. Micro-bump 850 connects a portion of an inner helical structure in the second stratum 791 to a connector in the third stratum 792. Micro-bumps 801, 802, 804, 806, 808, 810, 812, 821, 822, 824, 826, 828, 830, and 850 are shown and described in further detail in FIGS. 9-11.

FIG. 9 illustrates the inductor 700 without showing the strata 790, 791, or 792 so as not to obscure some of the details of the inductor 700. However, although the strata 790, 791, or 792 are not shown in FIG. 9, the strata 790, 791, or 792 should be considered present. In FIG. 9, a first section 901 represents an outer helical structure. The first section 901 includes the non-shaded portions including micro-bumps 801, 802, 804, 806, 808, 810, 821, 822, 824, 826, 828, 830, 951, 953, 955, 957, 959, 983, 985, 987 and 989. Sections 902 and 904 represent an inner helical structure similar to the sections 102 and 104 shown in FIG. 2. A transitional section 906 transitions the outer helical structure to the inner helical structure. For instance, the transitional section 906 is configured to bend, or turn, the electromagnetic coil of the inductor 700 approximately 180 degrees within itself and transition the outer helical structure to the inner helical structure so that the inner helical structure can fit within a frame of the outer helical structure. The inner helical structure includes micro-bump 850. The transitional section 906 includes micro-bump 812.

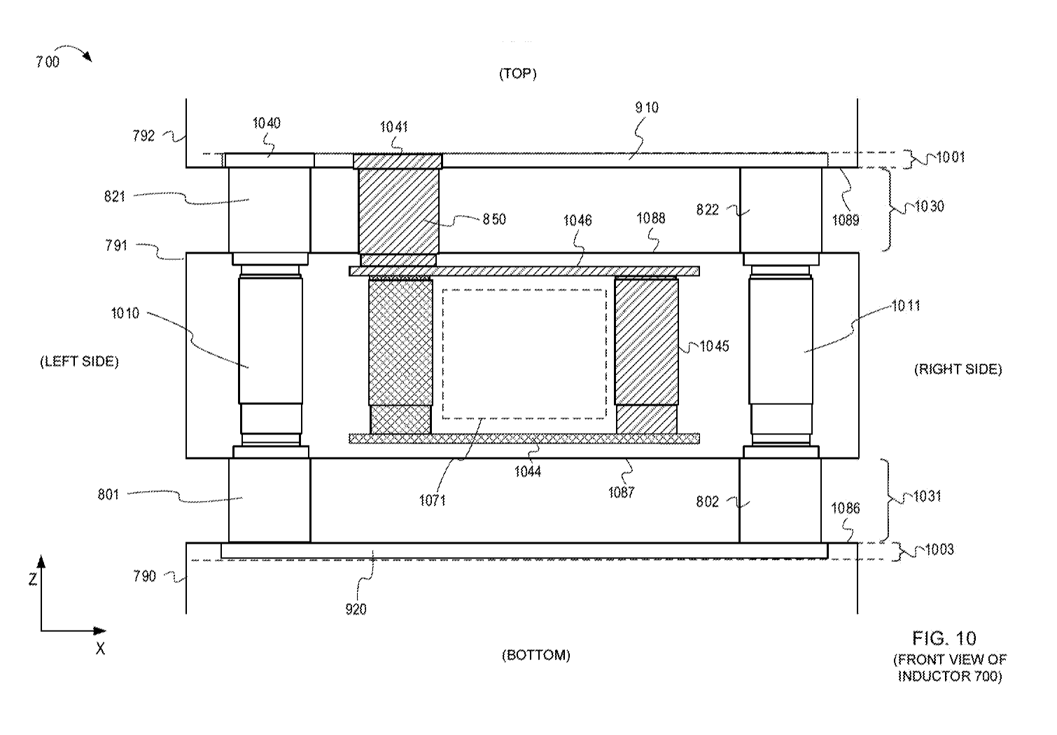

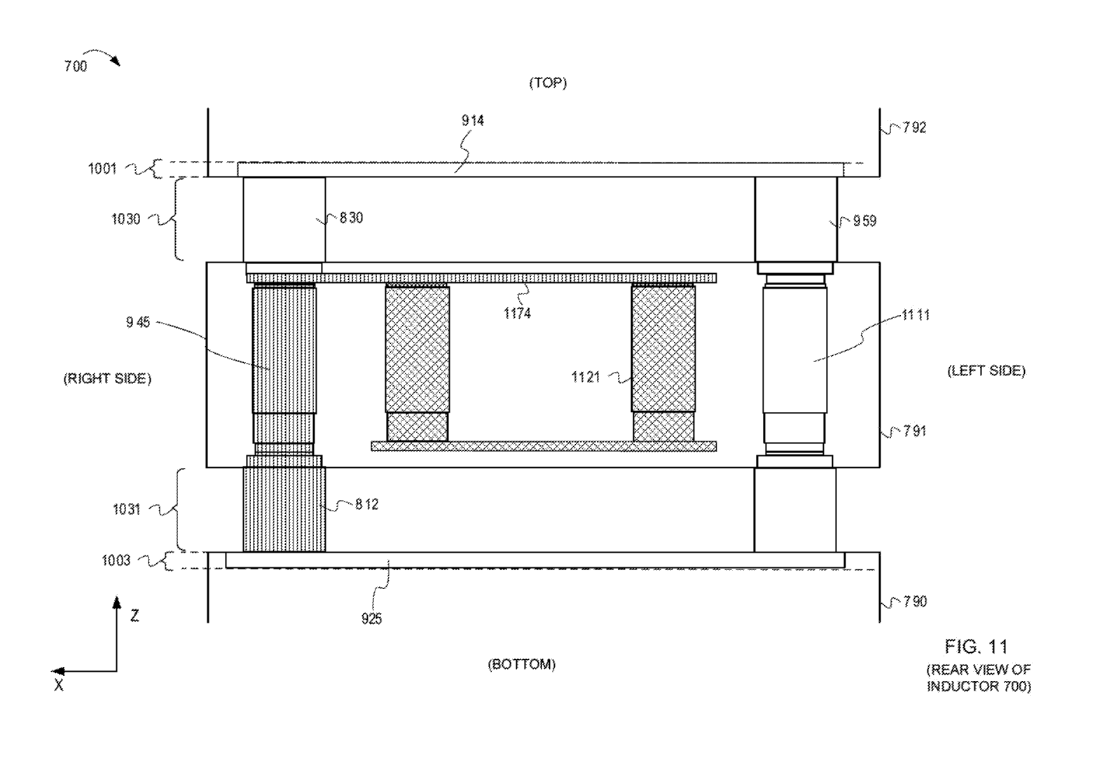

Furthermore, FIG. 9 illustrates orientation indicators (e.g., a front, a back, a left side, a right side, and a top) of the inductor 700. FIGS. 10 and 11 also show some of the same orientation indicators.

FIG. 10 illustrates a front view of the inductor 700. A metal layer 1001 is formed into a bottom portion of the stratum 792. First metals wires for the outer helical structure (e.g., metal wires 910, 911, 912, 913 and 914 shown in FIG. 9) are formed from the metal layer 1001. Still referring to FIG. 10, another metal layer 1003 is formed into a top portion of the stratum 790. Second metal wires (e.g., wires 920, 921, 922, 923, 924, and 925 shown in FIG. 9) are formed from the metal layer 1003. The vertical sides of the outer helical structure may include a combination of vias and micro-bumps. For example, in FIG. 10, on the left side of the outer helical structure, a vertical column includes via 1010 as well as microbumps 801 and 821. On the right side of the outer helical structure, another vertical column of the outer helical structure includes via 1011 as well as microbumps 802 and 822. Via 1010 and 1011 may be TSVs that extend vertically through the entire thickness of the stratum 791. The TSVs may have a non-uniform or uniform shape depending on the fabrication process.

The outer helical structure winds through the strata 790, 791, and 792. A description of how the outer helical structure winds through the strata 790, 791, and 792 will now be described using both FIG. 9 and FIG. 10. For example, a first winding of the outer helical structure begins at a metal connector 1040. The metal connector 1040 is within the stratum 792. For example, the metal connector 1040 may be formed from the metal layer 1001. The metal connector 1040 is connected to a top portion of the micro-bump 821. The micro-bump 821 extends vertically through a space 1030 between the stratum 792 and the stratum 791. A bottom of the micro-bump 821 connects to a top of the via 1010. The via 1010 extends vertically entirely through the stratum 791. A bottom of the via 1010 connects to a top of the micro-bump 801. The micro-bump 801 extends vertically through a space 1031 between the stratum 791 and the stratum 790. A bottom of the micro-bump 801 connects to metal wire 920. Metal wire 920 is within the stratum 790. The metal wire 920 extends horizontally across a width of the outer helical structure and connects to a bottom of the micro-bump 802. The micro-bump 802 extends vertically through the space 1031. A top of the micro-bump 802 connects to a bottom of via 1011. The via 1011 extends vertically through the stratum 791. A top of the via 1011 connects to a bottom of micro-bump 822. The micro-bump 822 extends vertically through the space 1030. A top of the micro-bump 822 connects to a bottom surface of metal wire 910. The metal wire 910 extends horizontally across the width of the outer helical structure as shown in FIGS. 9 and 10. Referring to FIG. 9, the metal wire 910 connects to the top of micro-bump 951, thus completing the first winding of the outer helical structure. Other windings of the outer helical structure continue in a repeated manner toward the back of the inductor 700 until reaching the portion 906. More specifically, until metal wire 925 connects to the micro-bump 812.

FIG. 11 will now describe the transitional section 906 (as shown in FIG. 9) as it transitions to the inner helical structure. In FIG. 11, a bottom of the micro-bump 812 connects to the metal wire 920. The micro-bump 812 extends vertically through the height of the space 1031. A top of the micro-bump 812 connects to a bottom of the via 945. The via 945 extends vertically through a portion of the stratum 791, but does not extend entirely through the stratum 791. Instead, a top of the via 945 connects to the metal wire 1174 which is contained within the stratum 791. The metal wire 1174 extends from the via 945 horizontally (to the left) toward the via 1121. The metal wire 1174 connects to the top of the via 1121. Via 1121 is part of the section 904 of the inner helical structure. The inner helical structure is contained within the stratum 791. The section 904 can be formed similarly to the formation of section 104 described in FIGS. 2-6. Furthermore, referring back to FIG. 9, the section 904 connects to section 902 as shown. Section 902 is formed similarly to the formation of section 102 described in FIGS. 2-6. For example, in FIG. 10, metal wire 1044 connects to a via 1045 of the inner helical structure. A bottom of the via 1045 connects to a top surface of the metal wire 1044. The via 1045 extends vertically through a portion of the stratum 791 and connects to a bottom surface of a metal wire 1046. The metal wire 1046 extends horizontally, to the left side, until connecting to the micro-bump 850. A top of the metal wire 1046 connects to a bottom of the micro-bump 850. The micro-bump 845 extends from the metal wire 1046, vertically through the space 1030, until connecting to the metal connector 1041 within the stratum 792.

The metal connector 1040 and the metal connector 1041 represent input and output connections for the inductor 700.

The inner helical structure of the inductor 700 is nested within the outer helical structure of the inductor 700. Consequently, the inductor 700 has a greater inductance density than an inductor without nested helical structures. Further, because the inner helical structure is contained in the space within the outer helical structure, then inductor 700 has a better Q-factor per area than an inductor without nested helical structures.

Only three strata are illustrated in the examples of FIGS. 7-11. However, other examples not illustrated can include any number of strata and any number of nested helical structures. For example, an additional inner helical structure could be nested within the space 1071 inside the inner helical structure. In other examples, the vias of the inner helical structure shown for inductor 700 could extend through multiple strata, similar to how the vias of the outer helical structure extend through multiple strata. In some embodiments, the vias for the inner helical structure can extend through fewer strata than the outer helical structure (e.g., so that the inner helical structure is contained within the space of the outer helical structure).

Nested Helical Transformer

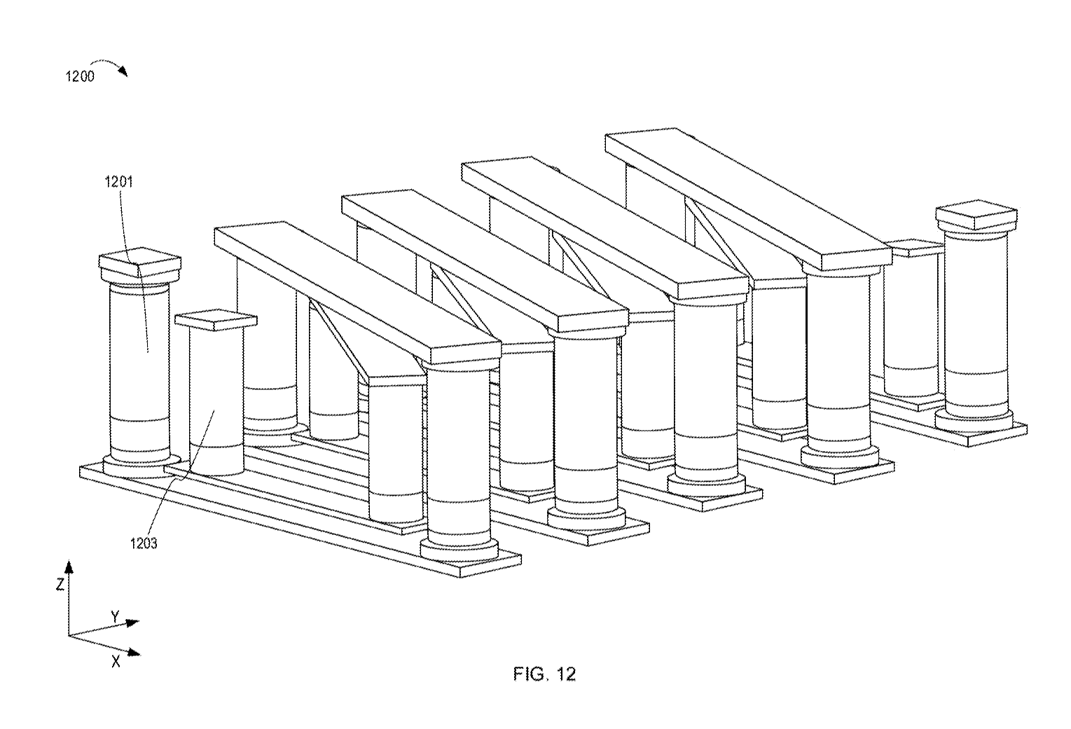

In other embodiments, using some of the above disclosed techniques, a nested helical transformer can be formed with two separate helical coils nested within each other. FIG. 12 illustrates an example of a nested helical transformer (“transformer 1200”). In FIG. 12, the transformer 1200 includes an outer helical coil 1201 (“outer coil 1201”) and an inner helical coil 1203 (“inner coil 1203”). The inner coil 1203 is nested within the outer coil 1201.

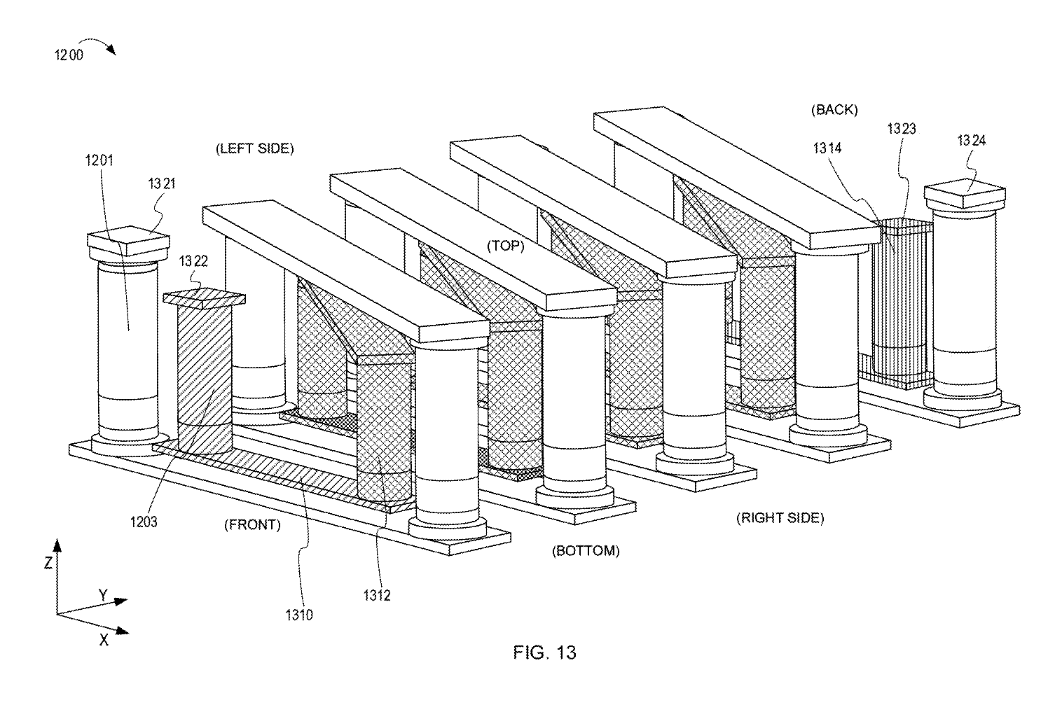

FIG. 13 shows an example of the transformer 1200 with the inner coil 1203 shaded. A front portion 1310 of the inner coil 1203 is connected to a middle portion 1312 of the inner coil 1203. The middle portion 1312 of the inner coil 1203 connects to a back portion 1314 of the inner coil 1203.

The outer coil 1201 has an input and an output. For instance, metal connector 1321 is an input for the outer coil 1201. Metal connector 1324 is an output for the outer coil 1201. The inner coil 1203 also has an input and an output. For instance, metal connector 1322 is an input for the inner coil 1203. Metal connector 1323 is an output for the inner coil 1203.

Based on the shape of the transformer 1200, the outer coil 1201 and the inner coil 1203 enclose nearly the same flux. In some embodiments, the transformer 1200 has a lower leakage flux and lower energy loss than a transformer that does not have nested helical coils.

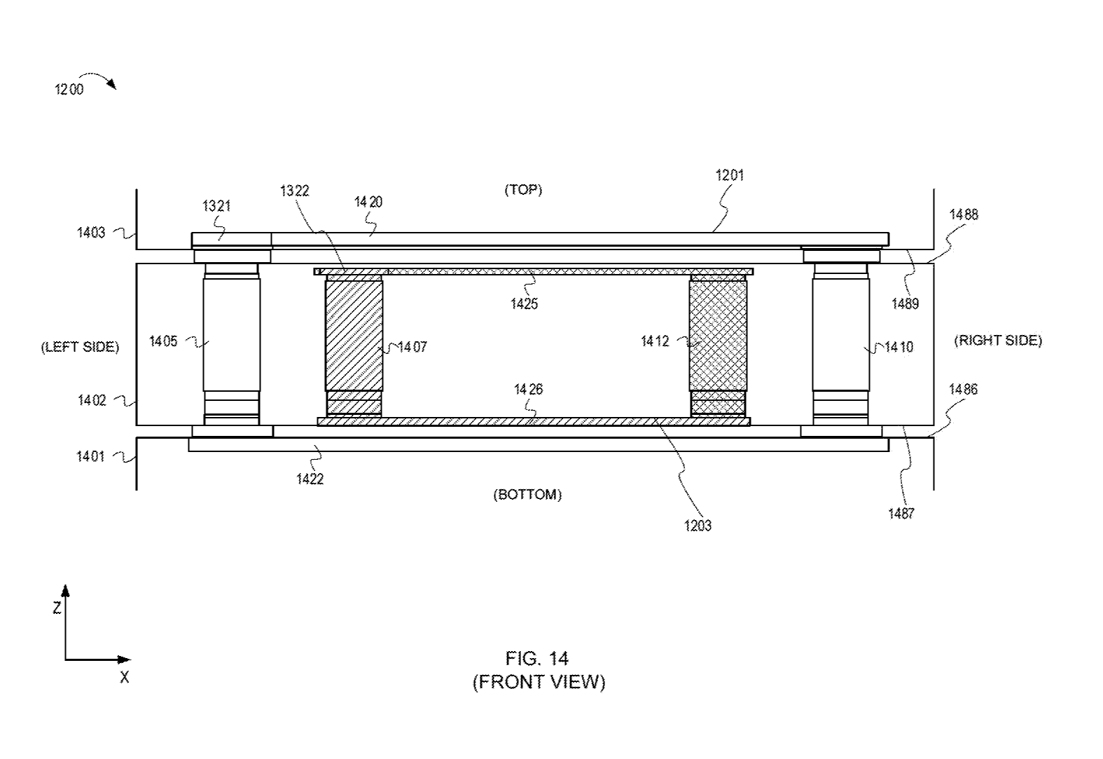

One or more portions of the outer coil 1201 are included in at least a portion of one or more strata (e.g., in one or more portions of a silicon substrate or semiconductor device package). One or more portions of the inner coil 1203 are also included at least a portion of one or more strata (e.g., in one or more portions of a silicon substrate or semiconductor device package). FIG. 14 illustrates an example of the transformer 1200 that is included in multiple strata. FIG. 14, is a front view of the transformer 1200. Orientation indicators in FIG. 14 (e.g., top, left-side, right-side, and bottom) are based on those illustrated in FIG. 14. In FIG. 14, three strata are depicted, a first stratum 1401, a second stratum 1402, and a third stratum 1403. One or more vias (e.g., via 1405 and via 1410) for the outer coil 1201 extend vertically through the second stratum 1402 and connect to one or more metal wires (e.g. metal wire 1420) of the outer coil 1201 in the third stratum 1403 and one or more metal wires (e.g., metal wire 1422) of the first stratum 1401. The inner coil 1203, however, is contained within the second stratum 1402. For example, vias (e.g., via 1407 and 1412) for the inner coil 1203 connect to one or more metal wires (e.g. metal wires 1425 and 1426) of the inner coil 1203 in the second stratum 1402.

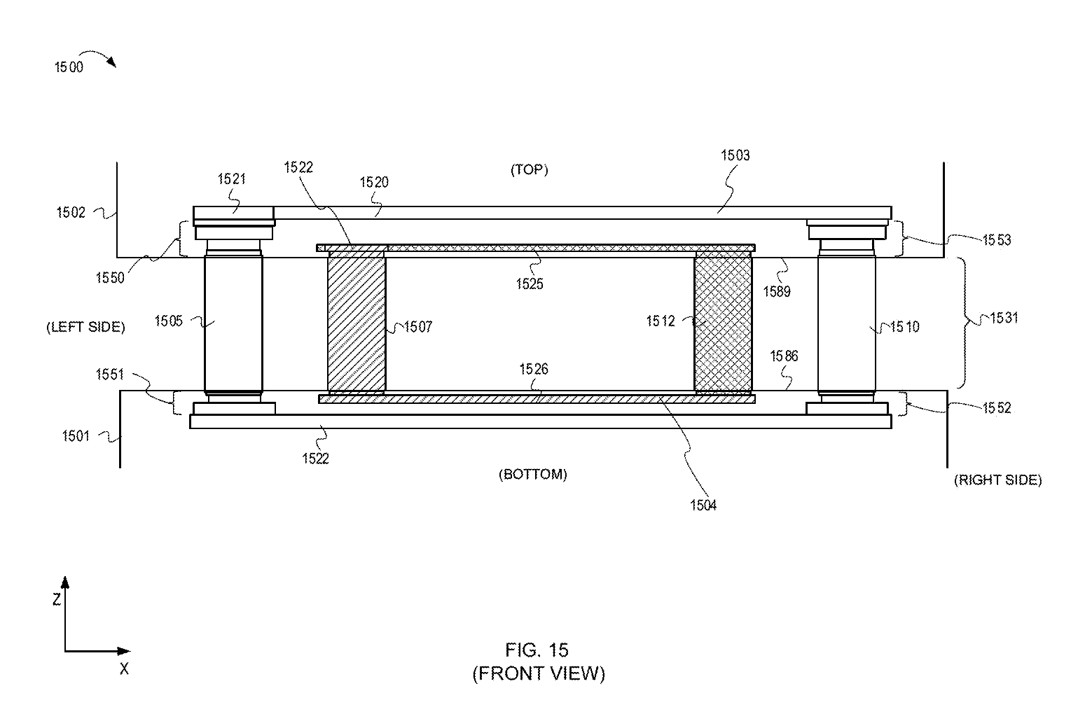

FIG. 15 illustrates another example of a nested helical transformer (“transformer 1500”), with an inner helical coil (“inner coil 1504”) and an outer helical coil (“outer coil 1503”). FIG. 15 includes shading and orientation markers that are similar to those shown in FIG. 14. Transformer 1500 is similar to transformer 1200, however, for transformer 1500, two strata (i.e., first stratum 1501 and second stratum 1502) are illustrated as opposed to the three strata (i.e., strata 1401, 1402 and 1403) shown in FIG. 14. Further, in FIG. 15, portions of the outer coil 1503 and portions of the inner coil 1504 are included in the first stratum 1501 and in the second stratum 1502. Further, in FIG. 14, vias (e.g., vias 1405, 1410, 1407, and 1412) extend through a portion of stratum 1402. However, in FIG. 15 there are no vias. Instead, micro-bumps are used to form the transformer 1500. For example, metal connector 1521 is inside stratum 1502. Several first layers of conductive materials are formed into an intra-stratum connector (“connector 1550”) between the metal connector 1521 and a micro-bump 1505. The micro-bump 1505 connects to the connector 1550 and extends vertically through a space 1531 between the first stratum 1501 and the second stratum 1502. The micro-bump 1505 connects to a second connector 1551, which connects to a metal wire 1522 inside stratum 1501. The metal wire 1522 may be formed from thick metal. The metal wire 1522 is at a bottom of the outer coil 1503. The metal wire 1522 extends vertically (left to right) across a width of the outer coil 1503 and connects to connector 1552. Connector 1552 connects to a micro-bump 1510, which connects to connector 1553 within the second stratum 1502. The connector 1553 connects to a metal wire 1520 within the second stratum 1502. The metal wire 1520 may be formed from thick metal. The metal wire 1520 is at a top of the outer coil 1503 of the transformer 1500. The outer coil 1503 may continue as such for any number of windings until terminating with an output connector, which may be co-planar with the metal connector 1521 and the metal wire 1520 (e.g., similar to the metal connector 1324 shown in the transformer 1200 in FIG. 13).

Further, portions of the inner coil 1504 are in both the first stratum 1501 and in the second stratum 1502. For example, for the inner coil 1504, a metal connector 1522 is inside of the second stratum 1502. The metal connector 1522 connects to a micro-bump 1507 in between the second stratum 1502 and the first stratum 1501. The micro-bump 1507 connects to metal wire 1526 inside the first stratum 1501. The metal wire 1526 connects to a micro-bump 1512. The micro-bump 1512 connects to a metal wire 1525 within the second stratum 1502. The inner coil 1504 may continue as such for any number of windings until terminating with an output. A top surface of the output may be co-planar with a top surface of the metal connector 1522 and with a top surface of the metal wire 1525.

The transformer 1200 is different from the helical inductors 100 or 700 in that the transformer 1200 does not include the transitional portion that the inductors 100 or 700 include for connecting an inner helical structure with an outer helical structure. Instead, the transformer 1200 includes an outer, helically shaped electromagnetic coil (e.g., outer coil 1201) that is electrically separate from a nested inner, helically shaped electromagnetic coil (e.g., inner coil 1203). Further, the transformer 1200 has two inputs and two outputs, whereas the inductors 100 and 700 have only one input and one output. Furthermore, for the transformer 1200, all vias for the outer coil are of a first height, and all vias for the inner helical coil are of a second height smaller than the first height. The inductors 100 and 700, however, have a transitional portion with at least one via that is smaller than vias for the outer helical structure, yet larger than vias for the inner helical structure.

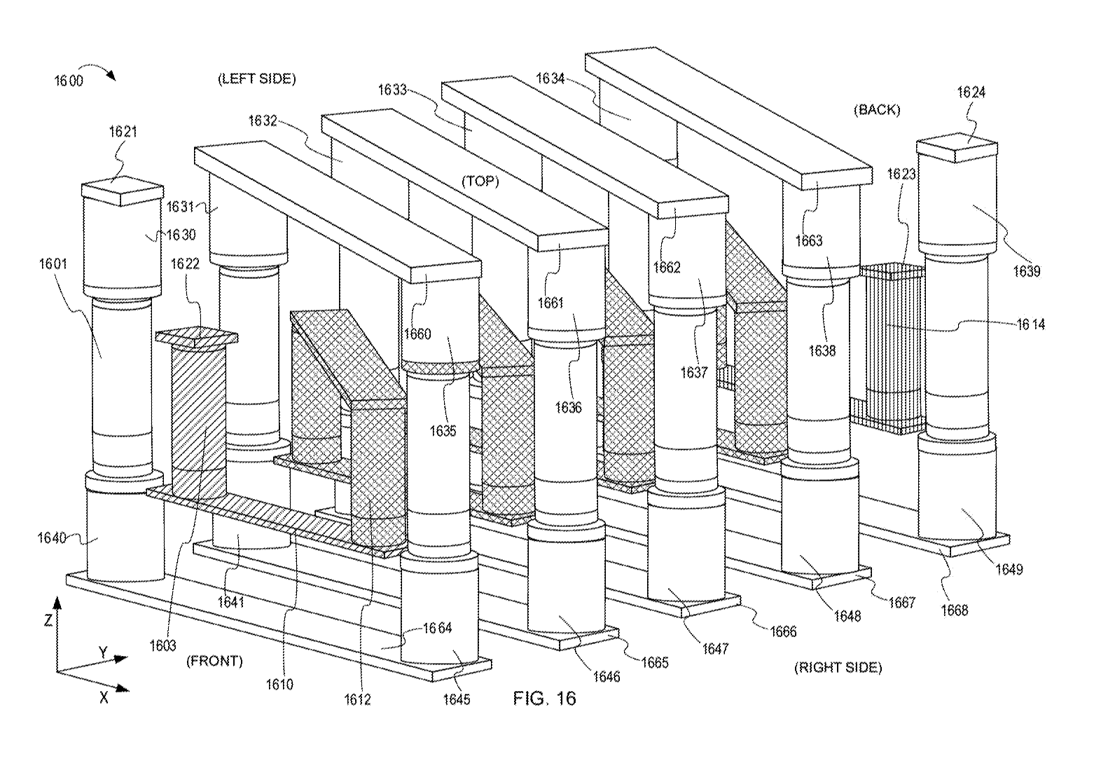

FIG. 16 illustrates an example of a nested helical transformer (“transformer 1600”) formed across multiple strata. Transformer 1600 has some similar elements to transformer 1200. For example, transformer 1600 has an inner helical coil (“inner coil 1603”) that is nested within an outer helical coil (“outer coil 1601”). The inner coil 1603 has a front section 1610, a middle section 1612, and a back section 1614. The outer coil 1601 has an input connection 1621 and an output connection 1624. The inner coil 1603 has an input connection 1622 and an output connection 1623. However, the transformer 1600 has micro-bumps that may be between different strata into which the transformer 1600 is formed. For example, inner coil 1603 (including metal connector 1622 and metal connector 1623) may be contained within a middle stratum. Micro-bumps 1630, 1631, 1632, 1633, 1634, 1635, 1636, 1637, 1638, and 1639 may be between the middle stratum and an upper stratum. Metal wires 1660, 1661, 1662, and 1663, as well as metal connector 1621 and metal connector 1624 may be formed into the upper stratum. Micro-bumps 1640, 1641, 1645, 1646, 1647, 1648, and 1649 may be between the middle stratum and a lower stratum. Metal wires 1664, 1665, 1666, 1667, and 1668 may be formed into the lower stratum.

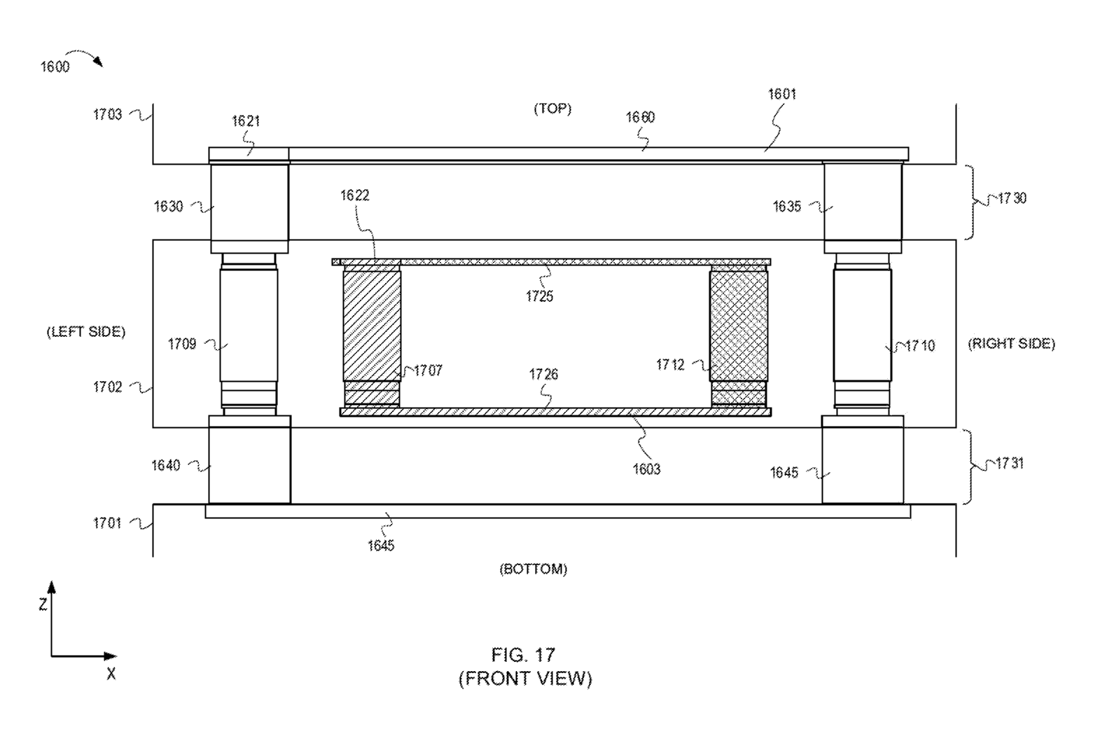

FIG. 17 illustrates a front view of the transformer 1600. Shown in FIG. 17 are three strata, a first stratum 1701, a second stratum 1702 and a third stratum 1703. Some of the orientation indicators in FIG. 17 (e.g., top, left-side, right-side) are based on those illustrated in FIG. 16. Metal connector 1621 is inside the third stratum 1703. A top of micro-bump 1630 connects to the metal connector 1621. The micro-bump 1630 extends vertically through a space 1730 between the third stratum 1703 and the second stratum 1702. A bottom of the micro-bump 1630 connects to a top of via 1709 in the second stratum 1702. The via 1709 extends vertically through the second stratum 1702. A bottom of via 1709 connects to a top of micro-bump 1640. The micro-bump 1640 extends vertically through a space 1731 between the second stratum 1702 and the first stratum 1701. A bottom of the micro-bump 1640 connects to a top of the metal wire 1645. The metal wire 1645 extends horizontally across a width of the outer coil 1601 and connects to a bottom of micro-bump 1645. A top of the micro-bump 1645 connects to a bottom of via 1710. The via 1710 extends vertically through the second stratum 1702 and connects to a bottom of micro-bump 1635. A top of the micro-bump 1635 connects to a bottom of the metal wire 1660. A winding of the outer coil 1601 is thus formed. Additional windings of the outer coil 1601 may be formed similarly. The inner coil 1603 is contained within the second stratum 1702. The metal connector 1622 connects to via 1707, which connects to metal wire 1726. Metal wire 1726 connects to via 1712, which connects to metal wire 1725. Thus a winding of the inner coil 1603 is formed. Additional windings of the inner coil 1603 may be formed similarly.

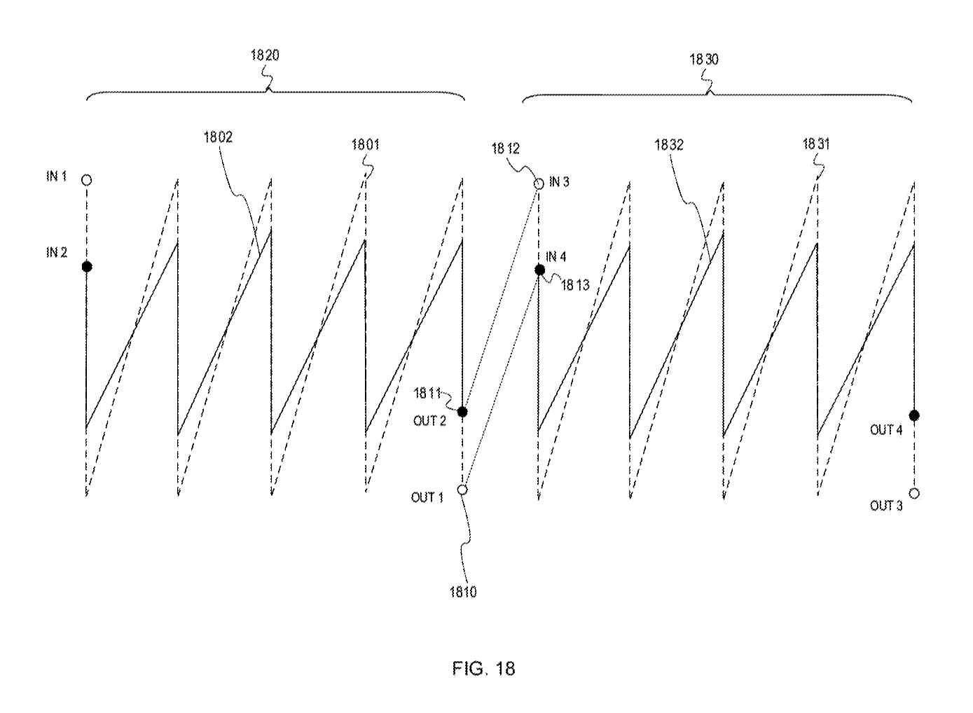

In some embodiments, a first nested helical transformer can be connected with a second nested helical transformer in series to form symmetrical windings. For example, an outer helical coil of the first transformer can be connected in series with an inner helical coil of the second transformer. Further, the inner helical coil of the first transformer can be connected in series with the outer helical could of the second transformer. For example, in FIG. 18, an output 1810 of an outer helical coil 1801 of a first nested helical transformer (“first transformer 1820”) is connected in series with an input 1813 of an inner helical coil 1832 of a second nested helical transformer (“second transformer 1830”). Further, the output 1811 of an inner coil 1802 of the first transformer 1820 is connected in series with an input 1812 of an outer coil 1831 of the second transformer 1830. By connecting the first transformer 1820 and the second transformer 1830 as shown, electrical properties of the outer coil 1802 equalize electrical properties of the inner coil 1832. Likewise, electrical properties of the outer coil 1832 equalize electrical properties of the inner coil 1802.

It should be noted that for multi-strata structures, although orientation markers may show a “top” and a “bottom” for purposes of description of the multi-strata structure, each of the strata may be formed separately according to different orientations and then connected with micro-bumps. For example, referring to FIG. 10, each of the first stratum 790, second stratum 791 and third stratum 792 may be formed separately, using individual formation techniques and operations. The individual formation of each strata results in each having an individual front surface (top) and a back surface (bottom) when formed. For instance, stratum 791 may be formed to have a front surface 1086 and a back surface (not shown). In some embodiments, the second stratum 791 may be formed according to similar techniques, where tools, operations, etc., may be similarly performed and/or oriented, such that the second stratum 791 also has a front surface 1088 and a back surface 1087. The third stratum 792 may also be formed to have a front surface 1089 and a back surface (not shown). The second stratum 791 is connected to the first stratum 790 such that the front surface 1086 of the first stratum 790 is facing the back surface 1087 of the second stratum 791. However, the third stratum 792 is flipped around such that the front surface 1089 of the third stratum 792 is facing the front surface 1088 of the second stratum 791.

Similarly, referring to FIG. 14, a front surface 1486 of the first stratum 1401 faces a back surface 1487 of the second stratum 1402. A front surface 1488 of the second stratum 1402 faces a front surface 1489 of the third stratum 1403. In some embodiment, a back-end-of-line (BEOL) metal layer, or interconnect metal, may be formed at or near a front surface of a stratum. Thus, in some embodiments, the metal wire 1201 is from an interconnect metal layer of the third stratum 1403. The metal wire 1425 may be from an interconnect metal layer of the second stratum 1402. The metal wire 1426 may be from a metal redistribution layer (RDL). The metal wire 1422 may be from an interconnect metal layer of the first stratum 1401. In the example shown in FIG. 15, however, a front surface 1586 of the first stratum 1501 faces a front surface 1589 of the second stratum 1502. Thus, in some examples, the metal wire 1525 may be from a first interconnect layer (e.g., an interconnect “upper” metal) of the second stratum 1502, and metal wire 1520 may be from a second interconnect layer (e.g., an interconnect “lower” metal) of the second stratum 1502. Likewise, the metal wire 1526 may be from a first interconnect layer (e.g., an interconnect “upper” metal) of the first stratum 1501, and metal wire 1522 may be from a second interconnect layer (e.g., an interconnect “lower” metal) of the first stratum 1501.

Example Operations

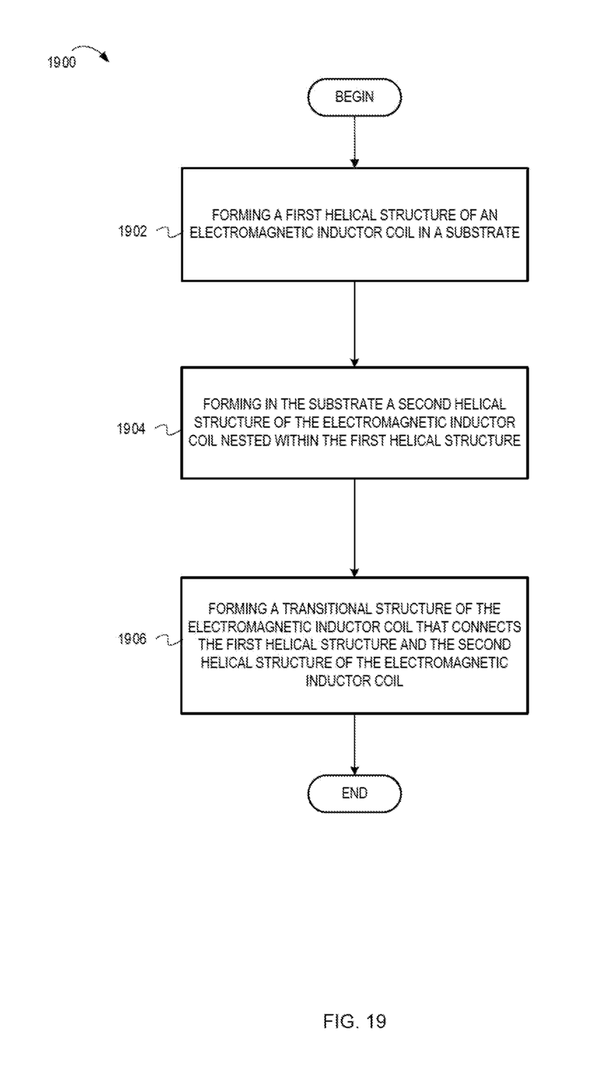

FIG. 19 is a flowchart depicting example operations for forming a nested helical inductor according to some embodiments. For exemplary purposes, operations associated with the blocks in FIG. 19 will be described as being performed by a semiconductor fabrication system (“system”). FIG. 19 illustrates a flow 1900 that the system can perform.

Referring to FIG. 19, the system forms a first helical structure of an electromagnetic inductor coil in a substrate (1902). In some embodiments, the substrate includes at least a layer of semi-conductive material. In some embodiments, at least a portion of the first helical structure of the electromagnetic inductor coil is inside the substrate. For instance, the system can form vias in the substrate and connect metal wires to the vias. In some embodiments, the system connects vias and metal wires together in a spiraling pattern as if wound around a box. In some embodiments, the system forms the first helical structure to have a double-helical, equiangular shaped form or frame (“first helical frame”).

For example, in some embodiments, the system forms a first set of vias (e.g., TSVs) through the substrate as a first side of the first helical frame. In some embodiments, the system further forms a second set of vias (e.g., TSVs) through the substrate as a second side of the first helical frame opposite to the first side. In some embodiments, the system further forms first metal wires as a third side of the helical frame. The system can further connect the first metal wires to first ends of the first set of vias and to first ends of the second set of vias. The system can further form second metal wires as a fourth side of the helical frame opposite to the third side. The system can further connect the second metal wires to second ends of the first set of vias and to second ends of the second set of vias.

In some embodiments, the system forms the first set of vias approximately parallel to the second set of vias. Further, in some embodiments, the system forms the first metal wires approximately parallel to the second metal wires. Further, in some embodiments, the system forms the first set of vias and the second set of vias approximately perpendicular to the first metal wires and the second metal wires.

In some embodiments, the system can form the first set of vias and the second set of vias in a first substrate. Further, the system can form the first metal wires inside a second substrate. Further, the system can form the third metal wires inside a third substrate. In some embodiments, the system can form first micro-bumps at the first side of the first helical structure. The first micro-bumps connect the first metal wires to the first ends of the first set of vias. Further, in some embodiments, the system can form second micro-bumps at the second side of the first helical structure. The second micro-bumps connect the first metal wires to the first ends of the second set of vias. Further, in some embodiments, the system can form third micro-bumps at the first side of the first helical structure. The third micro-bumps connect the second metal wires to the second ends of the first set of vias. Further, in some embodiments, the system can form fourth micro-bumps at the second side of the first helical structure. The fourth micro-bumps connects the second metal wires to the second ends of the second set of vias.

Referring still to FIG. 19, the system forms in the substrate a second helical structure of the electromagnetic inductor coil nested within the first helical structure (1904). In some embodiments, the first helical frame has a space within a body of the frame. The system can form the second helical structure within the space. In some embodiments, the second helical structure has a double-helical, equiangular shaped form or frame. In some embodiments, the system forms a third set of vias through the substrate as a first side of the second frame (of the second helical structure). In some embodiments, the system forms the first side of the second frame approximately parallel to the first side of the first frame (of the first helical structure). In some embodiments, the system forms a fourth set of vias through at least a portion of the substrate as a second side of the second helical frame. In some embodiments, the second side of the second helical frame is parallel to a second side of the first helical frame. In some embodiments, the system forms third metal wires as a third side of the second helical frame. The third metal wires connect to first ends of the third set of vias and to first ends of the fourth set of vias. In some embodiments, the system forms fourth metal wires as a fourth side of the second frame. The fourth metal wires connect to second ends of the third set of vias and to second ends of the fourth set of vias. In some embodiments, the system forms the third set of vias approximately parallel to the fourth set of vias. Further, in some embodiments, the system form the third metal wires approximately parallel to the fourth metal wires.

Referring still to FIG. 19, the system forms a transitional structure of the electromagnetic inductor coil that connects the first helical structure and the second helical structure of the electromagnetic inductor coil (1906). The system forms the transitional structure to transition a first set of helical windings of the first helical structure into a second set of helical windings of the second helical structure. The second set of helical windings have one or more smaller dimensions than the first set of helical windings of the first helical structure. In some embodiments, the system forms the second set of helical windings to fit within the space inside the first helical structure. In some embodiments, the system forms the first set of helical windings of the outer helical structure to wind a given distance in a first direction until connecting to the transitional structure. The system can form the transitional structure to turns the electromagnetic inductor coil around to face a second direction opposite to the first direction. The system can form the second set of helical windings so that the second set of helical windings winds from the transitional structure wind, within the space inside the first helical structure, for the given distance in the second direction. In some embodiments, the system forms a number of the first set of helical windings equivalent to a number of the second set of helical windings.

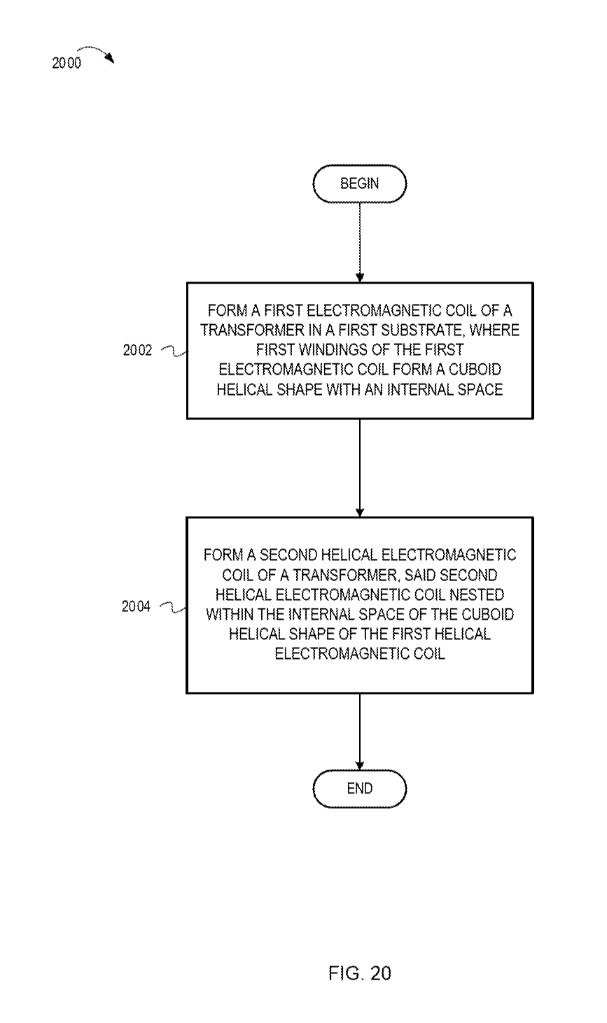

FIG. 20 is a flowchart depicting example operations for forming a nested helical transformer according to some embodiments. For exemplary purposes, operations associated with the blocks in FIG. 20 will be described as being performed by a semiconductor fabrication system (“system”). FIG. 20 illustrates a flow 2000 that the system can perform.

Referring to FIG. 20, the system forms a first electromagnetic coil of a transformer in a first substrate (2002). The first electromagnetic coil (“first coil”) has first windings that form a cuboid helical shape. The cuboid helical shape has an internal space.

In some embodiments, at least a portion of the first coil is inside a first semi-conductive substrate. In some embodiments, the system forms a first set of vias through the first semi-conductive substrate as a first side of the first cuboid, double-helix shape. In some embodiments, the system forms a second set of vias through the first semi-conductive substrate as a second side of the first cuboid, double-helix shape. The second side is opposite to the first side. In some embodiments, the system forms first metal wires as a third side of the first cuboid, double-helix shape. In some embodiments, the system connects the first metal wires to first ends of the first set of vias. In some embodiments, the system connects the second metal wires to first ends of the second set of vias. In some embodiments, the system forms second metal wires as a fourth side of the first cuboid, double-helix shape. The fourth side is opposite to the third side. In some embodiments, the system connects the second metal wires to second ends of the first set of vias. In some embodiments, the system connects the second to second ends of the second set of vias. In some embodiments, the first set of vias are parallel to the second set of vias, the first metal wires are parallel to the second metal wires, and the first set of vias and the second set of vias are perpendicular to the first metal wires and the second metal wires.

In some embodiments, the system forms at least an additional portion of the first helical electromagnetic coil inside a second semi-conductive substrate different from the first semi-conductive substrate.

In some embodiments, the first set of vias and the second set of vias are in the first semi-conductive substrate, while the first metal wires are inside a second semi-conductive substrate separate from the first semi-conductive substrate. In some embodiments, the third metal wires are inside a third semi-conductive substrate.

In some embodiments, the system forms the first coil in multiple strata of a semi-conductive device. For example, the system can form first micro-bumps at the first side of the first cuboid, double-helix shape. The first micro-bumps connect the first metal wires to the first ends of the first set of vias. Further, the system can form second micro-bumps at the second side of the first cuboid, double-helix shape. The second micro-bumps connect the first metal wires to the first ends of the second set of vias. In some embodiments, the system forms third micro-bumps at the first side of the first cuboid, double-helix shape. The third micro-bumps connect the second metal wires to the second ends of the first set of vias. In some embodiments, the system forms fourth micro-bumps at the second side of the first cuboid, double-helix shape, wherein the fourth micro-bumps connect the second metal wires to the second ends of the second set of vias.

Referring to FIG. 20, the system forms a second helical electromagnetic coil of a transformer (2004). The second helical electromagnetic coil (“second coil”) is nested within the internal space of the cuboid helical shape of the first helical electromagnetic coil. In some embodiments, at least a portion of the second coil is inside the first semi-conductive substrate. In some embodiments, the second coil has a cuboid helical shape.

In some embodiments, the system forms a third set of vias through the first semi-conductive substrate as a first side of the second cuboid, double-helix shape. In some embodiments, first side of the second cuboid, double-helix shape is parallel to the first side of the first cuboid, double-helix shape. In some embodiments, the system forms a fourth set of vias through the first semi-conductive substrate as a second side of the second cuboid, double-helix shape. In some embodiments, the second side of the second cuboid, double-helix shape is parallel to the second side of the first cuboid, double-helix shape. In some embodiments, the system forms third metal wires as a third side of the second cuboid, double-helix shape. In some embodiments, the third metal wires connect to first ends of the third set of vias and to first ends of the fourth set of vias. Furthermore, in some embodiments, the system forms fourth metal wires at a fourth side of the second cuboid, double-helix shape. The fourth metal wires can connect to second ends of the third set of vias and to second ends of the fourth set of vias. In some embodiments, the third vias are parallel to the fourth vias. Further, in some embodiments, the third metal wires are parallel to the fourth metal wires.

Example Environments

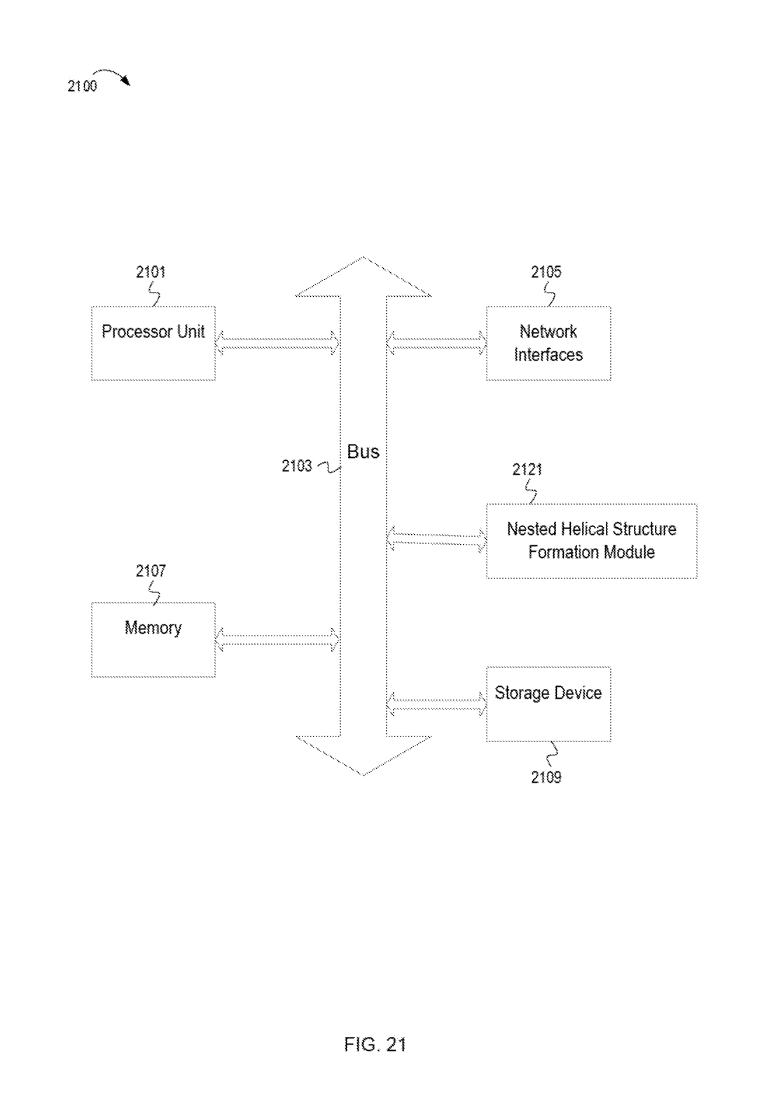

FIG. 21 depicts an example computer system 2100. The computer system 2100 includes a processor unit 2101 (possibly including multiple processors, multiple cores, multiple nodes, and/or implementing multi-threading, etc.). The computer system 2100 includes memory 2107. The memory 2107 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable or computer readable media. The computer system 2100 also includes a bus 2103 (e.g., PCI bus, ISA, PCI-Express bus, HyperTransport® bus, InfiniBand® bus. NuBus bus, etc.), a network interface 2105 (e.g., an ATM interface, an Ethernet interface, a Frame Relay interface, SONET interface, wireless interface, etc.), and a storage device(s) 2109 (e.g., optical storage, magnetic storage, etc.). The computer system 2100 also includes a nested helical structure formation module 2121. The nested helical structure formation module 2121 can control formation (e.g., design, simulation, test, layout, manufacture, etc.) of nested helical inductors and/or nested helical transformers according to some embodiments. The nested helical structure formation module 2121 can include individual components or parts that manage different aspects or parts of the formation of the nested helical inductors and/or the nested helical transformers. Any one of these functionalities may be partially (or entirely) implemented in hardware and/or on the processing unit 2101. For example, the functionality may be implemented with an application specific integrated circuit, in logic implemented in the processing unit 2101, in a co-processor on a peripheral device or card, etc. Further, realizations may include fewer or additional components not illustrated in FIG. 21 (e.g., video cards, audio cards, additional network interfaces, peripheral devices, etc.). The processor unit 2101, the storage device(s) 2109, and the network interface 2105 are coupled to the bus 2103. Although illustrated as being coupled to the bus 2103, the memory 2107 may be coupled to the processor unit 2101.

The computer system described above and the method described in the flow above may be used in a design, simulation, test, layout, and manufacture of circuit boards on which integrated circuit chips may be connected according to some embodiments. The method may include includes processes, machines and/or mechanisms for processing design structures or devices to generate logically or otherwise functionally equivalent representations of structures and/or devices described above and shown in FIGS. 1-2, 3A-3B, and 4-20. The design structures processed and/or generated may be encoded on machine-readable transmission or storage media to include data and/or instructions that when executed or otherwise processed on a data processing system generate a logically, structurally, mechanically, or otherwise functionally equivalent representation of hardware components, circuits, devices, or systems. Machines include, but are not limited to, any machine used in a circuit board design process, such as designing, manufacturing, or simulating a circuit board, a circuit board component, a circuit board device, or circuit board system. For example, machines may include machines and/or equipment for generating masks, computers or equipment for simulating design structures, any apparatus used in the manufacturing or test process, or any machines for programming functionally equivalent representations of the design structures into any medium (e.g. a machine for programming a programmable gate array). Design structures may include an input design structure and/or a logical simulation design structure. Design structures may also or alternatively comprise data and/or program instructions that when processed generate a functional representation of the physical structure of a circuit board, a portion of a circuit board, and/or hardware devices on the circuit board. Whether representing functional and/or structural design features, a design structure may be generated using electronic computer-aided design (ECAD) such as implemented by a core developer/designer. When encoded on a machine-readable data transmission, gate array, or storage medium, a design structure may be accessed and processed by one or more hardware and/or software modules within a design process to simulate or otherwise functionally represent a printed circuit board assembly, an electronic component on a printed circuit board, a circuit formed on or associated with the circuit board, electronic or logic modules, apparatus, device, or system such as those shown above. As such, a design structure may comprise files or other data structures including human and/or machine-readable source code, compiled structures, and computer-executable code structures that when processed by a design or simulation data processing system, functionally simulate or otherwise represent circuits or other levels of hardware logic design. Such data structures may include hardware-description language (HDL) design entities or other data structures conforming to and/or compatible with lower-level HDL design languages such as Verilog and VHDL, and/or higher level design languages such as C or C++.

A design process can employ and incorporate hardware and/or software modules for synthesizing, translating, or otherwise processing a design/simulation functional equivalent of the components, circuits, devices, or structures shown above to generate a file which may contain design structures. The file may comprise, for example, compiled or otherwise processed data structures representing a list of wires, discrete components, models, etc. that describe the connections to other elements and circuits in a circuit board design. The file may be synthesized using an iterative process in which the file is resynthesized one or more times depending on design specifications and parameters for the device. As with other design structure types described herein, the file may be recorded on a machine-readable data storage medium or programmed into a programmable gate array. The medium may be a non-volatile storage medium such as a magnetic or optical disk drive, a programmable gate array, a compact flash, or other flash memory. Additionally, or in the alternative, the medium may be a system or cache memory, buffer space, or electrically or optically conductive devices and materials on which data packets may be transmitted and intermediately stored via the Internet, or other networking suitable means.

A design process may include hardware and software modules for processing a variety of input data structure types. Such data structure types may reside, for example, within library elements and include a set of commonly used elements, circuits, and devices, including models, layouts, and symbolic representations, for a given manufacturing technology. The data structure types may further include design specifications, characterization data, verification data, design rules, and test data files which may include input test patterns, output test results, and other testing information. A design process may further include, for example, standard mechanical design processes such as stress analysis, thermal analysis, mechanical event simulation, process simulation for operations such as casting, molding, etc. One of ordinary skill in the art of mechanical design can appreciate the extent of possible mechanical design tools and applications used in a design process without deviating from the scope and spirit of the embodiments of the inventive subject matter described. A design process may also include modules for performing standard design processes such as timing analysis, verification, design rule checking, place and route operations, etc.

A design process may employ and incorporate logic and physical design tools such as HDL compilers and simulation model build tools to process a design structure together with some or all of the depicted supporting data structures along with any additional mechanical design or data (if applicable), to generate additional design structures that reside on a storage medium or programmable gate array in a data format used for the exchange of data of mechanical devices and structures (e.g. information stored in a IGES, DXF, Parasolid XT, JT, DRG, or any other suitable format for storing or rendering such mechanical design structures). The additional design structures can comprises one or more files, data structures, or other computer-encoded data or instructions that reside on transmission or data storage media and that when processed by an ECAD system generate a logically or otherwise functionally equivalent form of one or more of the embodiments of the invention shown in FIGS. 1-2, 3A-3B, and 4-21. In one embodiment, a design structure may comprise a compiled, executable HDL simulation model that functionally simulates the devices shown above.

A design structure may also employ a data format used for the exchange of layout data of circuit boards and/or symbolic data format. A design structure may comprise information such as, for example, symbolic data, map files, test data files, design content files, manufacturing data, layout parameters, wires, levels of metal, vias, shapes, data for routing through the manufacturing line, and any other data required by a manufacturer or other designer/developer to produce a device or structure as described above and shown in figures above. A design structure may be transferred amongst different entities involved in designing and/or manufacturing.

As will be appreciated by one skilled in the art, aspects of the present inventive subject matter may be embodied as a system, method or computer program product. Accordingly, aspects of the present inventive subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present inventive subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While the embodiments are described with reference to various implementations and exploitations, it will be understood that these embodiments are illustrative and that the scope of the inventive subject matter is not limited to them. In general, techniques for forming nested helical structures, circuit boards, circuit board assemblies, stacked (e.g., 3D) semi-conductive devices, etc. as described herein may be implemented with facilities consistent with any hardware system or hardware systems. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. An apparatus comprising:
a first helical electromagnetic coil of a transformer, wherein at least a first portion of the first helical electromagnetic coil is inside a first semi-conductive substrate, and wherein the first helical electromagnetic coil has a shape with an internal space; and
a second helical electromagnetic coil of the transformer, wherein at least a portion of the second helical electromagnetic coil is nested within the internal space of the first helical electromagnetic coil, and wherein the at least the portion of the second electromagnetic coil is inside the first semi-conductive substrate.

2. The apparatus of claim 1, wherein the first helical electromagnetic coil comprises first vias formed through the first semi-conductive substrate, and wherein the second helical electromagnetic coil is contained within the first semi-conductive substrate.

3. The apparatus of claim 1, wherein one or more of a second portion of the first helical electromagnetic coil and a second portion of the second helical electromagnetic coil are inside one or more additional semi-conductive substrates different from the first semi-conductive substrate.

4. The apparatus of claim 1, wherein the first helical electromagnetic coil comprises a first cuboid, double-helix frame with a space inside the first cuboid, double-helix frame, and wherein the second helical electromagnetic coil comprises a second cuboid, double-helix frame contained within the space inside the first cuboid, double-helix frame.

5. The apparatus of claim 4, wherein the first cuboid, double-helix frame comprises:
a first set of vias of the first helical structure formed through the first semi-conductive substrate at a first side of the cuboid, double-helix frame;
a second set of vias of the first helical structure are formed through the first semi-conductive substrate at a second side of the cuboid, double-helix frame opposite to the first side;
first metal wires at a third side of the cuboid, double-helix frame, wherein the first metal wires connect to first ends of the first set of vias and to first ends of the second set of vias; and
second metal wires at a fourth side of the cuboid, double-helix frame opposite to the third side, wherein the second metal wires connect to second ends of the first set of vias and to second ends of the second set of vias.

6. The apparatus of claim 5, wherein the first set of vias are parallel to the second set of vias, wherein the first metal wires are parallel to the second metal wires, and wherein the first set of vias and the second set of vias are perpendicular to the first metal wires and the second metal wires.

7. The apparatus of claim 5, wherein the first set of vias and the second set of vias are in the first semi-conductive substrate, wherein the first metal wires are inside a second semi-conductive substrate, wherein the third metal wires are inside a third semi-conductive substrate.

8. The apparatus of claim 7, wherein first micro-bumps at the first side of the first helical structure connect the first metal wires to the first ends of the first set of vias, wherein second micro-bumps at the second side of the first helical structure connect the first metal wires to the first ends of the second set of vias, wherein third micro-bumps at the first side of the first helical structure connect the second metal wires to the second ends of the first set of vias, and wherein fourth micro-bumps at the second side of the first helical structure connect the second metal wires to the second ends of the second set of vias.

9. The apparatus of claim 5, wherein the second helical structure has a second cuboid, double-helix frame comprising:
a third set of vias formed through the first semi-conductive substrate at a first side of the second cuboid, double-helix frame parallel to the first side of the first cuboid, double-helix frame;
a fourth set of vias formed through the first semi-conductive substrate at a second side of the second cuboid, double-helix frame parallel to the second side of the first cuboid, double-helix frame;
third metal wires at a third side of the second cuboid, double-helix frame, wherein the third metal wires connect to first ends of the third set of vias and to first ends of the fourth set of vias; and
fourth metal wires at a fourth side of the second cuboid, double-helix frame, wherein the fourth metal wires connect to second ends of the third set of vias and to second ends of the fourth set of vias, wherein the third vias are parallel to the fourth vias, and wherein the third metal wires are parallel to the fourth metal wires.

10. An method of forming a nested helical transformer, said method comprising:
forming a first helical electromagnetic coil of the nested helical transformer, wherein at least a portion of the first helical electromagnetic coil is inside a first semi-conductive substrate, and wherein a helical shape of first windings of the first helical electromagnetic includes an internal space; and
forming a second helical electromagnetic coil of the transformer, wherein at least a portion of the second helical electromagnetic coil is nested within the internal space of the first helical electromagnetic coil, and wherein the at least the portion of the second electromagnetic coil is inside the first semi-conductive substrate.

11. The method of claim 10, wherein the forming the first helical electromagnetic coil comprises forming first vias through the first semi-conductive substrate, and wherein the second helical electromagnetic coil is contained within the first semi-conductive substrate.

12. The method of claim 10, wherein the forming the first helical electromagnetic coil comprises forming at least an additional portion of the first helical electromagnetic coil inside a second semi-conductive substrate different from the first semi-conductive substrate.

13. The method of claim 10, wherein the forming the first helical electromagnetic coil comprises forming a first cuboid, double-helix shape with a cuboid space inside the first cuboid, double-helix shape, and wherein the forming the second helical electromagnetic coil comprises forming a second cuboid, double-helix shape contained within the cuboid space inside the first cuboid, double-helix shape.

14. The method of claim 13, wherein the forming the first cuboid, double-helix shape comprises:
forming a first set of vias through the first semi-conductive substrate as a first side of the first cuboid, double-helix shape;
forming a second set of vias through the first semi-conductive substrate as a second side of the first cuboid, double-helix shape opposite to the first side;
forming first metal wires as a third side of the first cuboid, double-helix shape;
connecting the first metal wires to first ends of the first set of vias;
connecting the second metal wires to first ends of the second set of vias;
forming second metal wires as a fourth side of the first cuboid, double-helix shape opposite to the third side;
connecting the second metal wires to second ends of the first set of vias; and
connecting the second to second ends of the second set of vias.

15. The method of claim 14, wherein the first set of vias are parallel to the second set of vias, wherein the first metal wires are parallel to the second metal wires, and wherein the first set of vias and the second set of vias are perpendicular to the first metal wires and the second metal wires.

16. The method of claim 14, wherein the first set of vias and the second set of vias are in the first semi-conductive substrate, wherein the first metal wires are inside a second semi-conductive substrate, wherein the third metal wires are inside a third semi-conductive substrate.

17. The method of claim 16 further comprising:
forming first micro-bumps at the first side of the first cuboid, double-helix shape, wherein the first micro-bumps connect the first metal wires to the first ends of the first set of vias;
forming second micro-bumps at the second side of the first cuboid, double-helix shape, wherein the second micro-bumps connect the first metal wires to the first ends of the second set of vias;
forming third micro-bumps at the first side of the first cuboid, double-helix shape, wherein the third micro-bumps connect the second metal wires to the second ends of the first set of vias; and
forming fourth micro-bumps at the second side of the first cuboid, double-helix shape, wherein the fourth micro-bumps connect the second metal wires to the second ends of the second set of vias.

18. The method of claim 14, wherein the forming the second cuboid, double-helix shape comprises:
forming a third set of vias through the first semi-conductive substrate as a first side of the second cuboid, double-helix shape parallel to the first side of the first cuboid, double-helix shape;
forming a fourth set of vias through the first semi-conductive substrate as a second side of the second cuboid, double-helix shape parallel to the second side of the first cuboid, double-helix shape;
forming third metal wires as a third side of the second cuboid, double-helix shape, wherein the third metal wires connect to first ends of the third set of vias and to first ends of the fourth set of vias; and
forming fourth metal wires at a fourth side of the second cuboid, double-helix shape, wherein the fourth metal wires connect to second ends of the third set of vias and to second ends of the fourth set of vias, wherein the third vias are parallel to the fourth vias, and wherein the third metal wires are parallel to the fourth metal wires.

19. An apparatus comprising:
a first stratum of a stacked semi-conductive structure;
a second stratum of the stacked semi-conductive structure:
a first helical electromagnetic coil of a transformer, wherein a first portion of the first helical electromagnetic coil is inside the first stratum, wherein a second portion of the first helical electromagnetic coil is inside the second stratum, and wherein the first helical electromagnetic coil has a shape with an internal space; and
a second helical electromagnetic coil of the transformer, wherein at least a portion of the second helical electromagnetic coil is nested within the internal space of the first helical electromagnetic coil, and wherein the at least the portion of the second electromagnetic coil is inside the second stratum.

20. The apparatus of claim 19, wherein the first stratum is included in a first semi-conductive die, wherein the second stratum is included in a second semi-conductive die stacked on the first semi-conductive die, wherein the first portion of the first helical electromagnetic coil comprises metal wires inside the first stratum, wherein the second portion of the first helical electromagnetic coil comprises through-silicon vias inside the second stratum, and further comprising:
micro-bumps, wherein the micro-bumps connect the metal wires inside the first stratum to the through-silicon vias inside the second stratum.
